(19) United States
(12) Patent Application Publication
(10) Pub. No.: US 2006/0010430 A1
(43) Pub. Date: Jan. 12, 2006

(54) Device and process for the signature, the marking and the authentication of computer programs

(75) Inventors: Patrick Cousot, Bures-sur-Yvette (FR); Michel Riguidel, Paris (FR); Arnaud Venet, Sunnyvale, CA (US)

Correspondence Address: LOWE HAUPTMAN GILMAN & BERNER, LLP, 1700 DIAGNOSTIC ROAD, SUITE 300, ALEXANDRIA, VA, 22314, US

(73) Assignee: THALES

(21) Appl. No.: 11/133,380

(22) Filed: May 20, 2005

Related U.S. Application Data
(63) Continuation of application No. 10/476,249.

(30) Foreign Application Priority Data
May 4, 2001 (FR) FR 01/06024
Aug. 3, 2001 (FR) FR/01/10459

(51) Int. Cl. G06F 9/44

(52) U.S. Cl. 717/127

(57) ABSTRACT

The product/program and the process according to the invention make it possible to insert into an item of software in source code, in particular Java, watermarks which comply with the semantics of the program and are very difficult to detect. They make it possible to: compute a secret semantic signature of a software or hardware computer program from an infinity of possible secret semantic signatures; —mark a software or hardware computer program by inserting a visible or invisible watermark making it possible to retrieve an authenticator of the original program; retrieve the mark and extract this authenticator from the secret semantic signature of the watermarked software or hardware computer program. The secret semantic signature of the software or hardware computer program to be protected is characteristic of the semantics of said program. The inserted visible or invisible watermark of a software or hardware original computer program which makes it possible to retrieve an authenticator can be identified only by retrieving the secret semantic signature of the watermarked program, this requiring the possession of the secret (or computational power going beyond the possibilities of the computer hardware). The mark is resistant to methods of locating and of washing, without affecting the performance of the program to be protected.

### BACKGROUND OF THE INVENTION

The present invention belongs to the field of devices and processes for preventing and/or auditing computer program use not authorized by its author, its publisher or its distributor.

Devices and methods which verify that the person or the automaton seeking to use the program in a certain manner has the necessary rights come within the realm of prevention. Numerous devices and methods of this category have been envisaged for this purpose. In particular, U.S. Pat. No. 6,108,420 discloses a process and a device for producing a cryptographic imprint comprising the data of the license allocated to a user or a class of users and then for enciphering this imprint attached to the program to be protected.

The drawback of these devices and methods is that they presuppose the cooperation of the user who must not communicate the data of his license to other users or delete the part of the program, easily locatable in a source code since it is nonfunctional, which comprises these identification data.

Devices and methods which modify the program in a manner characteristic of the specimen of the program, in a manner which is not easily discernible by the user, without impairing its functionalities, come within the realm of audit. In particular, U.S. Pat. No. 5,559,884 discloses a method and a device for modifying in a manner characteristic of the specimen of the program the order of execution of blocks of said program.

The drawback of the devices and methods of this type is that they presuppose the insertion into said blocks of call and return instructions which can be easily located automatically and affect the performance of the program to be protected.

### SUMMARY OF THE INVENTION

The aim of the present invention is to remedy the drawbacks of this second type by disclosing a device and a method for computing a signature of the software to be protected, characteristic of said program, which is resistant to methods of locating without affecting the performance of the program to be protected and makes it possible to mark the software in a secret manner, the possessors of the secret being able to identify the mark and the signature.

To these ends, the invention discloses a computer product/program for processing the instructions of a computer program in source code, characterized in that it comprises a module for choosing as a function of predefined criteria those instructions of said software to which a transcoding program will be applied and a module for choosing from several the secret method of transcoding to be applied to said instructions.

Among the preferred embodiments, the invention also discloses a computer product/program of the above type whose secret transcoding method produces a semantic signature of the software.

According to a variant of the invention, the computer product/program of the above type comprises a module for inserting the transcoded instructions into the software.

The invention also discloses a process for processing the instructions of an item of software in source code, comprising a step for choosing as a function of predefined criteria those instructions of said program to which a transcoding program is applied and a step for choosing from several the secret transcoding method to be applied to said instructions as well as a preferred embodiment of the process in which the secret transcoding method produces via a semantic signature of the software as well as a variant of the invention in which the process furthermore comprises a step for inserting the transcoded instructions into the software.

### BRIEF DESCRIPTION OF THE DRAWINGS

The invention will be better understood and its various characteristics and advantages will emerge from the description which follows and from exemplary embodiments, and from its appended figures wherein:

FIG. 1 shows a basic diagram of the device and of the process for choosing the method of transcoding and transcoded instructions in the program;

FIG. 2 shows the diagram of the device and of the process in one of its variant embodiments;

FIG. 3 shows the basic diagram of the device and of the process for decoding a program modified according to the principle of FIG. 1;

FIG. 4 shows the diagram of the device and of the process for decoding a program modified according to the device and the process of FIG. 2.

### DESCRIPTION OF SPECIFIC ENBODIMENTS

The invention finally discloses a computer product/program and a process for recognizing the signature of the software.

In the claims, the description and the drawings, the expressions below are used with the indicated meaning:
A software protection/prevention process is a set of techniques which make the copying and fraudulent use of the software more difficult.
The compilation of a program is its translation into another language.
A computer program is an interpretable program or a program which can be compiled into an interpretable program.
A program is written in a certain programming language called the computer language of the program.
The interpretation of a program is the translation of the series of words of which it is composed into a series of actions.
The tagging of a document or a code consists in including visible or invisible marks, separate from the content of the object, which identify via fields the software object (designation, name of the author, name of the recipient, terms of the license of use) and a last digital signature field which completely relates the tag to the content of the object and at the same time guarantees the integrity of the object.
Watermarking consists in inserting visible or invisible marks inlaid into the body of the object. These marks dispersed within the body of the object are if not indiscernible at least indelible for anyone who does not know the secret key which generated the underlying pattern. A watermark is information hidden in digital data and which does not modify its meaning.
Watermarking a code consists in transforming it into an equivalent code without modifying its semantics, by adding hidden information which can be recovered by virtue of a secret called the key.
Two software codes are semantically equivalent if they have the same observable behavior, that is to say for example, if for any possible input, the outputs of the program are the same.
A signature process consists in supplementing an object with a characteristic data segment (summary), obtained with the aid of a secret method.
A washing technique is an attempt to erase the mark without changing the semantics.
A program, written in a particular language (for example Java), represents a series of instructions operating on the state of the computer system.
The state of the system at an instant t consists of the value of the variables of the program and of the system variables (queues of input/output flows).
A set of variables which is composed of the existing variables or/and of other additional variables is called the state of the associated system.
A semantics is a mathematical model defining the set of possible behaviors of a program upon execution at a certain level of observation.
“Obfuscation” is the transformation of a program into a semantically equivalent program in a form which is difficult for a computer scientist to understand.
Semantic Static Analysis is the automatic determination of semantic properties of the programs.

To ensure the security of any digital document (picture, sound, text, program, etc.), the conventional techniques of cryptology (electronic signatures, etc.) can be used. The security rules (for example the data relating to the license of the software, but these rules may be more personalized and more complex) relating to the document in respect of the authorized user are appended to the content to be made secure. These rules are written in another digital document (in general separate, such as for example a header, a tag, etc.).

The document is protected (or otherwise) by methods of cryptography (enciphering of the content, for example). The tag is protected by cryptographic techniques. The whole is generally bound together by cryptographic mechanisms (electronic signature, for example).

The drawback of these devices or methods is that they presuppose, in the distribution trust chain, the cooperation of all the players.

Noone may disclose the content of the tag or modify or delete the tag, if the latter is outside or inside the program. Nobody may usurp the identity of a legitimate user.

A program's identification data, even if the latter depend on the time, on the place and on the context may be diverted from their proper context.

These methods are universal and operate regardless of the nature of the document (text, signal, picture or program, etc.).

They have a major defect. They guarantee “bitwise” content:
they do not differentiate between tiny or huge modifications.
they do not differentiate between a modification which impairs the semantic or esthetic content of the original document and a modification which changes the “meaning” of this document.

The traditional cryptographic techniques merely grind any content into a digital “flour”. The method of grinding is not dependent on the nature, on the format, on the syntax, or on the semantics of the picture or of the text.

The security of an item of software depends on the security policy enforced by the proprietor of the software. This generally involves guaranteeing:
the availability of the software: precluding copying by pirates (for resale or illegitimate use); precluding unauthorized use from an original physical medium (CDROM);
the confidentiality of the software: precluding the understanding of the software (confidentiality of the algorithms of the source software, so as not to disclose the secret of the content of the program, the knowledge of the algorithms enabling understanding, similar rewriting, modification, etc.);
the integrity of the software: precluding the modifying of the software, either by not changing the semantic content, but by changing just the syntax (by modifying the name of the variables, by appending unnecessary instructions, etc., as in the “obfuscaters” for Java programs for example), or by changing its content (addition of a virus, addition or removal of a “patch”, conventional modification, borrowing of a chunk, etc.);
authentication to guarantee the origin and the content of the software (seal at a certain date): to ensure the anteriority of one watermark with respect to another, a security infrastructure (Added Value Trusted Third Party) is employed.

Methods of software watermarking which draw their inspiration from methods of watermarking other types of objects (pictures and sounds) are doomed to failure. Specifically, a computer code, by its nature, is completely different from audio and video objects and from images. For the latter, a slight loss of information does not modify the meaning: our sensory receptors are imperfect. Such is not the case for the computer code. It supports only compressions with no information loss. A modification, as tiny as it may be, may render the code nonfunctional. Only modifications which take account of the semantics are valid, for example the machine code optimization operations performed by compilers or obfuscation.

The drawback of software watermarking methods and devices is that they consider the code as a syntactic object and do not exploit its semantics. For this reason, it is easy to retrieve the watermark by syntactic analysis of the program, and to remove the mark by syntactic transformation.

Moreover, the general methods of software watermarking which have been developed hitherto give rise to easily locatable modifications of the program. The insertion of the jump and return instructions are for example automatically locatable. As far as the addition of graph structures is concerned, these structures are also easily identifiable in incompletely compiled codes. They also significantly encumber the running of the program.

In respect of the security of software, devices and methods which verify that the person or the automaton seeking to use the program in a certain manner has the necessary rights come within the realm of prevention. Numerous devices and methods of this category have been envisaged for this purpose. These involve devices for protecting software (their use generally depends on a hardware device: chip card, “dongle”) or for deterring fraudulent use of software (tag, banner, mark outside or inside a source program, machine language instructions in the executable program for identifying a context of use).

With the advance of new technologies and the rise in the number of Internet users, the protection of intellectual property is becoming a priority for software producers and vendors. Numerous protection devices and methods have been envisaged for this purpose. The family of devices which operate with specialized hardware will be noted. The watermarking of software and obfuscation are among the software methods of protection. The methods of watermarking which form part thereof are divided into two families:
the so-called dynamic methods, which take account of the temporal dimension of the execution of the program. The mark inserted may be obtained:
   by reading the output of the program for a given input.
   by reading the content of a variable during execution, for a given input.
   by noting the order of execution of the instruction blocks. In particular, U.S. Pat. No. 5,559,884 discloses a method and a device for modifying in a characteristic manner the order of execution of the blocks of said program, by inserting call and return instructions.
the so-called static syntactic methods, by virtue of which the mark is inserted and read without the execution of the program. The mark may be obtained:
   by studying the order of the instructions
   by examining the data used by the program (text, photos, sounds)

An account of all the existing methods is presented in the article by Coolberg and Thomborson, Software Watermarking: Models and Dynamic Embeddings (1998).

The invention belongs to a third category, that of semantic static devices and methods.

In this category, it is possible to find signatures which have an arbitrary meaning but which nevertheless remain hidden since the software itself comprises a considerable share of unstructured text.

However, in its preferred embodiment, the proposed device is applied in a manner specific to software programs which have given semantics, that is to say programs written in a programming language: it is especially applicable to interpreted programs (Java, PostScript, etc.) since these programs, once they have been written in machine languages, are easily decipherable by reverse engineering into their original form, understandable to a computer scientist. However, this device is of course also applicable to programs written in compilable languages (C, C++, Basic, Ada, Pascal, VHDL, Estérel, etc.) so as to authenticate and check the origin, the content or the destination.

The device in its preferred embodiment depends on the semantics of the language. Thus, the Java, VHDL, etc., watermarkers are different. They may have similar parts (in respect of the semantics of their arithmetic operations) but sometimes specific parts (the pointers in the C language). The device is applicable to markup languages in respect of the parts which contain programs (“scripts”). For XML, the other parts come within the realm of processes for watermarking images (imperceptible modifications to the on-screen or paper presentation). The device is also applicable to the parts which comprise operations (“macro” programs for “centering”, “justifying”, etc.).

In its preferred embodiment, the invention is based on the principles of semantic analysis.

Semantic analysis has been successfully applied to the certification of programs with draconian demand for reliability. (Reference 1: Abstract Interpretation: a unified lattice model for static analysis of programs by construction or approximations of fixpoints, P. Cousot & R. Cousot Jan. 17-19, 1977 reference 2: P. Lacan, J. N. Montfort, Le Vinh Quy Ribal, A. Deutsch, and F. Gouthin. The software reliability verification process: The Ariane 5 example. In Proceedings DA/A 98-Data Systems in Aerospace, Athens, Greece, ESA Publications, SP-422, May 25-28, 1998). To prove that a program executes faultlessly in an operational context, it is in theory necessary to study all the possible executions of said program. The above works have shown that proof of proper operation could be widened to the set of all possible executions. A program is regarded as constructed from a set of interrelated nodes. The instructions interlink the nodes and thus give rise to state transitions manifested by a change of one or more variables or/and a change of node.

When a semantic analysis of a program is carried out by abstract interpretation, a superset of the set of values that may be taken by a variable at a given node is computed by iteration [cf. “Abstract Interpretation: A unified lattice model for static analysis of programs by construction or approximation of fixpoints, P. Cousot & R. Cousot Jan. 17-19, 1977], for each variable and for each node.

Finding these supersets amounts to solving a fix point equation, an approximation of which is obtained by iteration. The examples will show methods of iteration in specific cases.

The problem which the inventor proposes to solve comes within the realm of the same approach: if the instructions added to the program to be protected belong to a subset of the invariants of said program, then said instructions will execute without error and will not modify the functionalities of said program. Several relevant subsets exist. It is judicious to choose a subset which is especially representative of the type of programs to be protected.

Although other solutions may be contemplated, it is currently preferred that the selecting of the instructions to be transcoded be done according to predefined criteria which include the selecting of subsets of invariants of the program, such as were defined above.

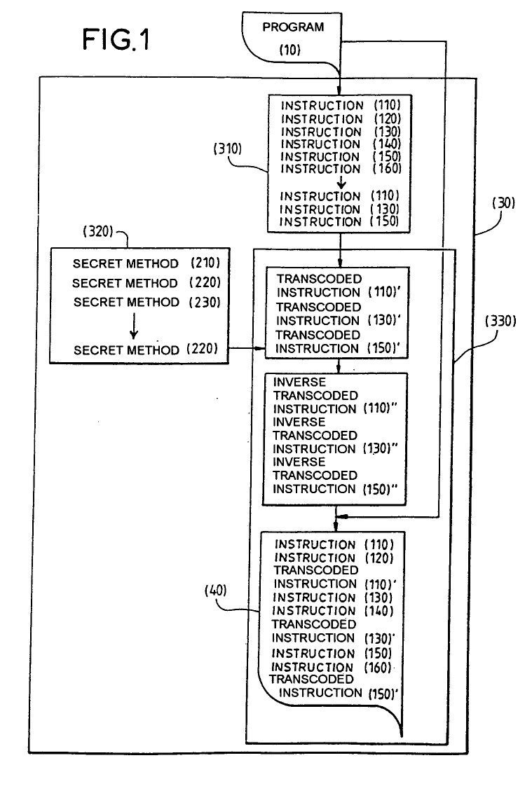

The module (310) of FIG. 1 makes it possible to perform this selecting of the instructions to be transcoded on the basis of the definition of the characteristics of said instructions (operations on integers, operations on floating-point numbers, initiation of variables, conditional loop, branching, etc.) by applying at least partially predefined criteria. The parameterization of the module (310) of the compiler (30) then allows the automatic selecting of the instructions to be transcoded. The intervention of the operator will also be possible in order to select an autonomous part of the program to be semantically signed. In Java for example, a program is likened to several classes composed of several methods, themselves possibly calling upon methods of other classes and of other packages. It is for this reason that in this particular case we shall prefer to sign the smallest autonomous entity of a Java program: the method.

The parts of the program to be signed should be the innovative and/or sensitive parts of the program. In general they relate to the algorithmic part of the program.

It is then a matter of choosing the transcoding method from among several by applying at least partially predefined criteria. This choice will depend on the sensitive nature of the information to be protected. The transcoding will therefore be more or less complex, given that it will have to comply with the semantics of the instructions to be transcoded, that is to say use the same vocabulary and the same grammar. The module (320) contains the possible methods of transcoding for each language. A transcoding method can have a degree of sophistication corresponding to the desired level of protection. For a given level of protection, an allotted number of possible parameters will be allocatable to users or classes of users.

In this list, each method of transcoding comprises a secret to be kept. Specifically, knowledge thereof will allow the decoding and hence the removal of the additional instructions, and this will delete any proof of possible subsequent unauthorized copying.

A transcoding table is an application which, with any operation performed on the state of the system, associates another operation performed on the state of the associated system. Creating a secret semantics therefore amounts to creating a corresponding static analysis, this consisting in defining the associated variables and the relationship between the actions operating on the state of the system and those operating on the associated variables.

It is for example possible to retain the same variables as those used by the program. Our transcoding table will give another interpretation of the instructions of the program, and will assign the associated variables values other than those which the initial variables would have taken. It is also possible to consider one and only one associated variable V, regardless of the initial variables. The series of instructions of the program will then be interpreted as a series of actions on the variable V.

The invention takes account of all the actions operating on the state of the system surrounding the computer program: such an action may affect the execution stack, modify the content of a system variable, call a function, order the reading of another variable, perform a logical or mathematical operation, create an object, send or receive an I/O stream, read an element of an array, etc.

Using a secret transcoding table enhances the signature and watermarking devices. Without this secret, it is very difficult to find the same signature (according to the conventional crypto argument: one cannot reasonably try all the possible combinations) and likewise it is almost impossible to retrieve a mark.

The proposed semantic signature characterizes the algorithm developed as such, and makes it possible to find the programs which have equivalent semantics.

The watermark is obtained by static analysis (after transcoding) of the program, which constitutes the key of our secret. There is little added noise, and the mark is therefore more resistant. The secret transcoding table makes detection of the mark more difficult.

At this juncture, it is possible to deposit the signature of the software (10), such as this signature was produced at the output of the module (320), with a Trusted Third Party (TTP). It therefore does not have to be inserted into the software (10). Authentication of the software will then be performed by the TTP by comparing the signature produced with the software to be analyzed with the signature which was deposited. In this case, the software is not protected against copying but the modifications which it may have undergone are detectable.

In a variant of the invention, the signature is inserted into the software (10) in the form of a mark.

The module (330) carries out on the one hand the transcoding of the instructions classed with the chosen method and on the other hand the insertion of the transcoded instructions into the program to be protected. The main algorithm of the module (330) has the aim of optimizing the placement of the transcoded instructions. It must be matched to the typology of the instructions and of the methods of transcoding. Compilers normally contain tools for code optimization and for verifying the propagation of the constants. The insertion of the transcoded instructions into the program to be protected will therefore have to comply with a certain number of minimum rules of robustness: it is necessary to ensure that the variables containing the watermarks have an influence on the outputs of the program. Stated otherwise, to preclude straightforward deletion by an optimizer, it is necessary to ensure that the content of the variable will be taken up again by an instruction of the initial program. It is also necessary to conceal the constants. To do this it is necessary to preclude the initializations of variable v with a constant value K, which are followed by an instruction of the type w=f(v), at the start of the program, since it is then easy for an optimizer to compute w directly. Conversely, it would be possible to favor the loops: in a loop, it is natural to initialize a variable (often to 1), and to increment it with each execution of the loop. Let us assume that in the loop, i takes values from a to b. It would be possible to insert the instruction w=f(i) into the loop and compute f so that w takes the value of the key for a value of i lying between a and b.

Once the semantic properties of the conjugate program have been determined, the instructions to be added to the initial program are computed via the inverse transcoding table. The added instructions must execute without error and must not modify the functionalities of said program. These transformations will be iso-semantic: for any identical input, the initial and watermarked programs will produce the same output. However, conversely, the internal execution environments will not be identical.

The mark is therefore a set of semantic properties of the transcoded program. Our watermarking device therefore consists in computing the instructions to be added to the initial program which will make it possible to obtain these new properties in the hidden space.

The insertion of the transcoded instructions into the program to be protected will have to comply with a certain number of minimum rules of robustness: it is necessary to ensure that the variables and the operations containing the watermarks give the impression that they have an influence on the outputs of the program. For example, to preclude straightforward deletion by an optimizer, it is necessary to ensure that the content of the variable will be taken up again by an instruction of the initial program. (Dynamic allocation of value).

It is important to note that the observation of the values taken by the variables during execution does not make it possible to retrieve the mark. On the one hand it is necessary to know the secret table to establish our conjugate program. On the other hand, it will not be possible to compute semantic properties in most cases other than by static analysis, and not by stepwise execution.

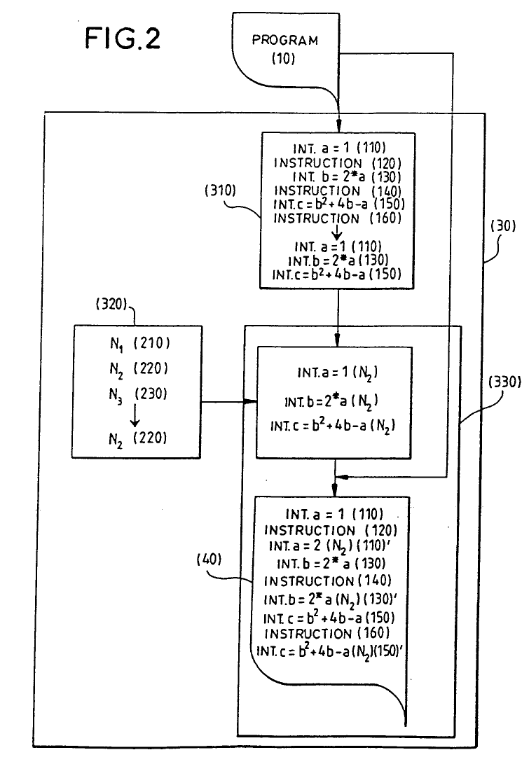

FIG. 2 sets forth an exemplary embodiment.

The method (310) of FIG. 2 will therefore be applied to each method of the program (or at least to those which have an algorithmic content which one wishes to protect). Selection of the instructions to be transcoded takes account of the execution dynamics of the Java code: the allocation of objects is performed “on the job”, that is to say as a function of the context of use of the resources of the processors, of the memory and of the inputs/outputs and, as the case may be, of the other members of the network. The instructions pertaining to the objects are therefore not recommended for watermarking since the latter should be independent of the context.

Watermarking should therefore pertain to scalar values or references to objects which are the only operands to be allotted on the program stack.

The predetermined criterion may comprise the choosing as instructions to be transcoded of the operations on integers, floating-point numbers or Boolean values. In the case of standard programs, operations on integers will be chosen. In the case of programs for computer-aided design, for simulation or for modeling in three dimensions where the operations on floating-point scalars are dominant, these operations will rather be chosen.

The module (310) of FIG. 2 is then used only to select the instructions (110), (130), (150) of the methods of the program (10) which comprise operations on integers.

A transcoding which complies with the semantics of the instruction then consists in performing the same operation modulo with any integer Nₖ less than 2³². An alternative consists in performing a different operation chosen from a permutation table, also in modular algebra. The module (320) has, in this case, the main function of preserving the table of secrets allocated to classes of given users for given programs.

The module (330) for computing and inserting the transcoded instructions is a series of instructions of the compiler (30) of the type described hereinbelow.

We wish to insert p marks into each selected method. Consider p numbers n₁, n₂, . . . , nₚ and p values of marks c₁<n₁; c₂<n₂; . . . Cₚ<nₚ constituting the secret set.

The series of macro-instructions of appendix 1 will be repeated for each method to be watermarked.

It is of course possible to repeat the procedure several times with different values of marks.

It is also possible to improve the robustness of the watermarking by using various techniques from modular algebra.

The strongest technique for relating the watermark to the program is to make the watermarking variables interfere with the original method. To do this it is necessary to be able to use properties of the watermarking variable which are transposable in 32-bit signed arithmetic. This is possible when the key K is a power of 2. Specifically, let us assume that K=2k. We then have:
X=v+a.2k in Z

We know, still in Z, that, for every j<k:
X% 2^{j}=v% 2^{j}
Where x % y denotes the operation which returns the remainder of the Euclidean division of x by y. It is noted that this property remains trivially true in Z/2³² which is the domain of Java integers. We can therefore use arithmetic properties of the watermark to modify computations of the method. For example, let us assume that K=2¹⁶ and that v=18. Then, regardless of the value of x, we always have x % 4=2.

If for example we have an explicit constant 1 in the original program, it can be replaced by x % 4−1. If, now, some dynamics have been added to x, we have a variable which seemingly takes stochastic values but of which a hidden invariant is used. The program thus modified is irreversibly degraded while retaining its original semantics. A pirate seeking to eliminate the watermarking variable x would then render the program unusable. A thorough study of the behavior of x is necessary in order to be able to retrieve the information thus concealed. Let us note that this technique of concealing constants can be carried out simply in an automatic and random manner.

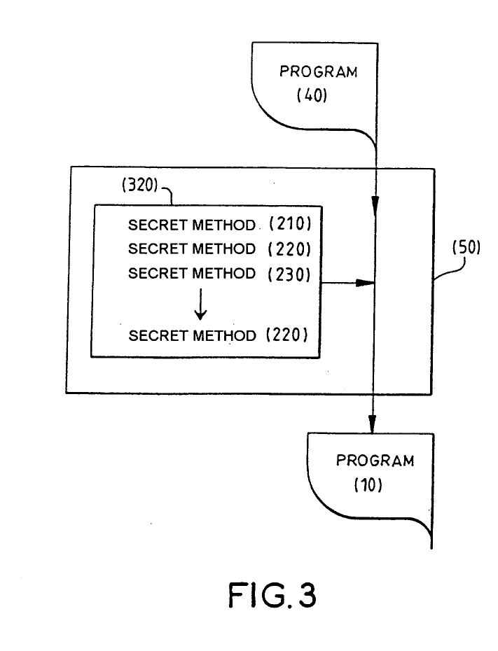

The generic method of reading the watermark is presented in FIG. 3. It presupposes the knowledge of at least some of the watermarking parameters. Several levels of a software distribution chain (purchaser, wholesaler, distributor, retailer) can thus be assigned marks which will be specific to them.

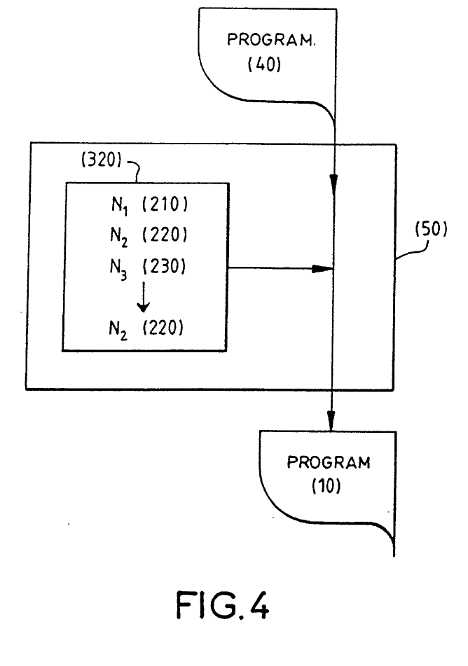

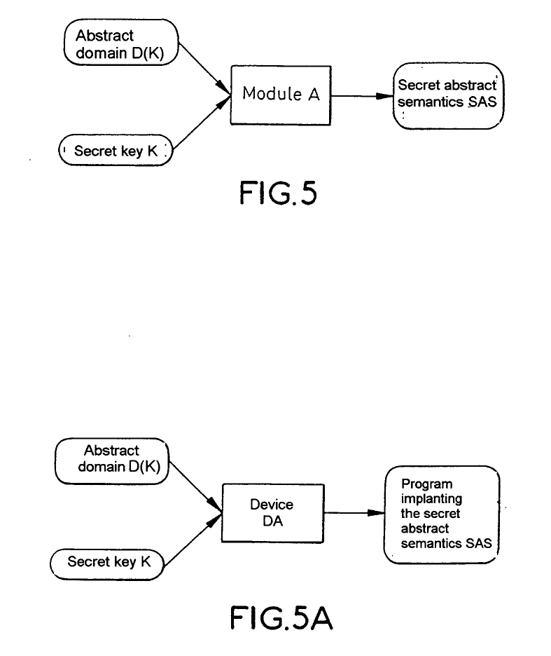

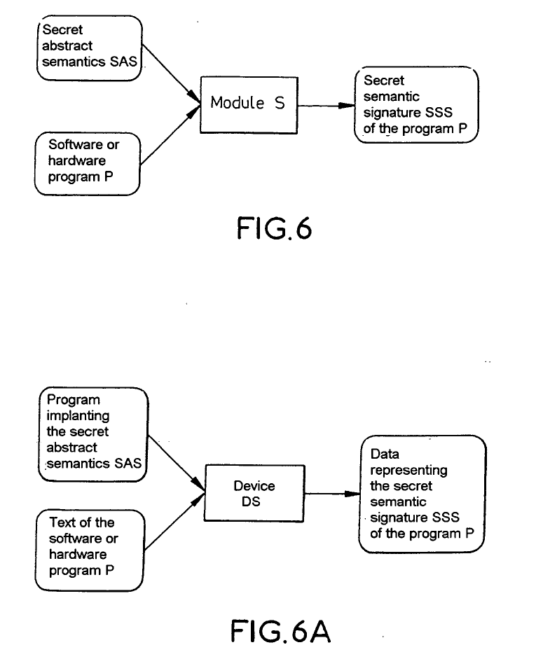

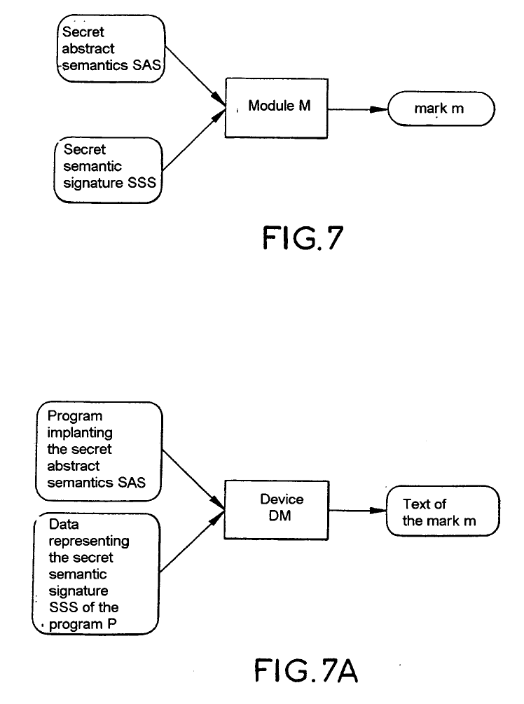

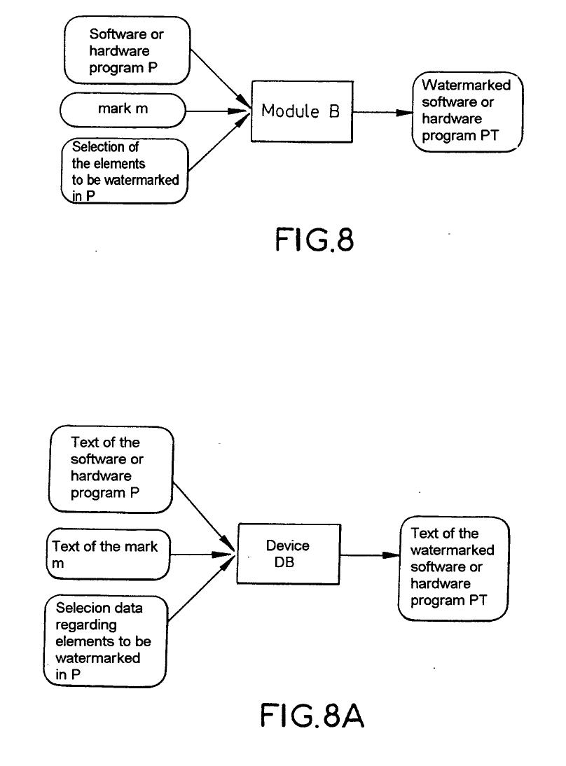

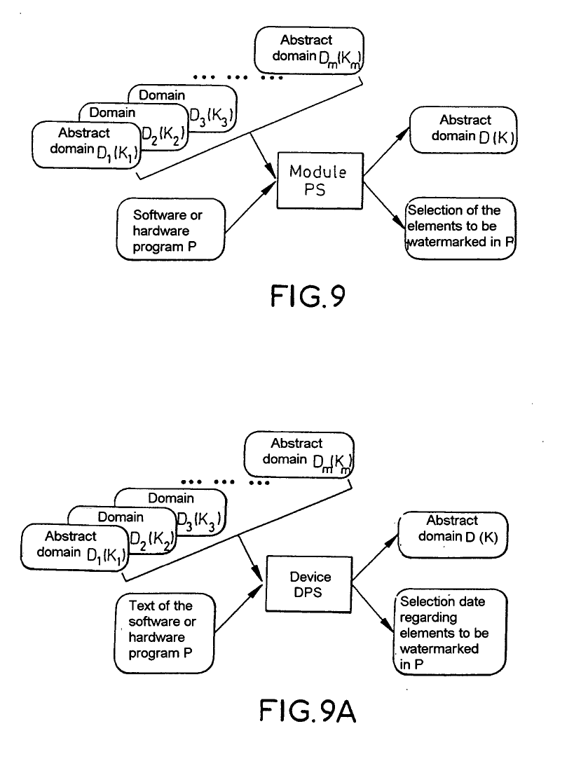

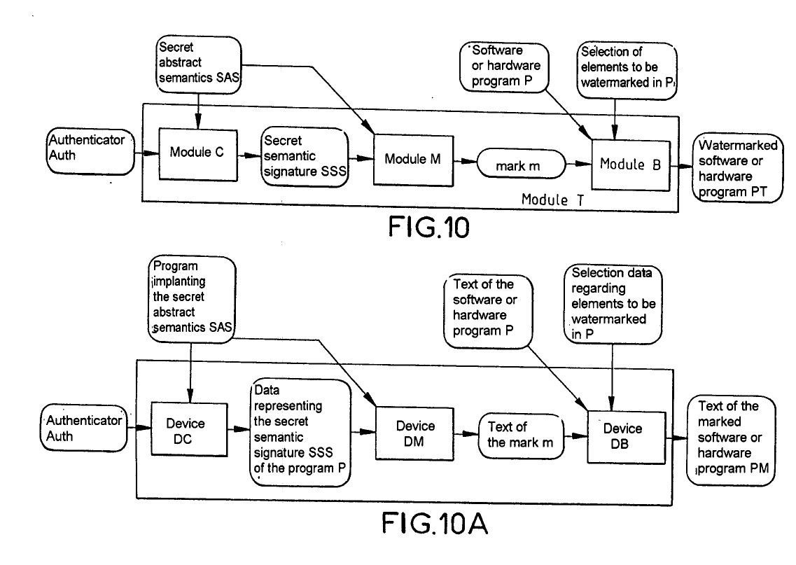

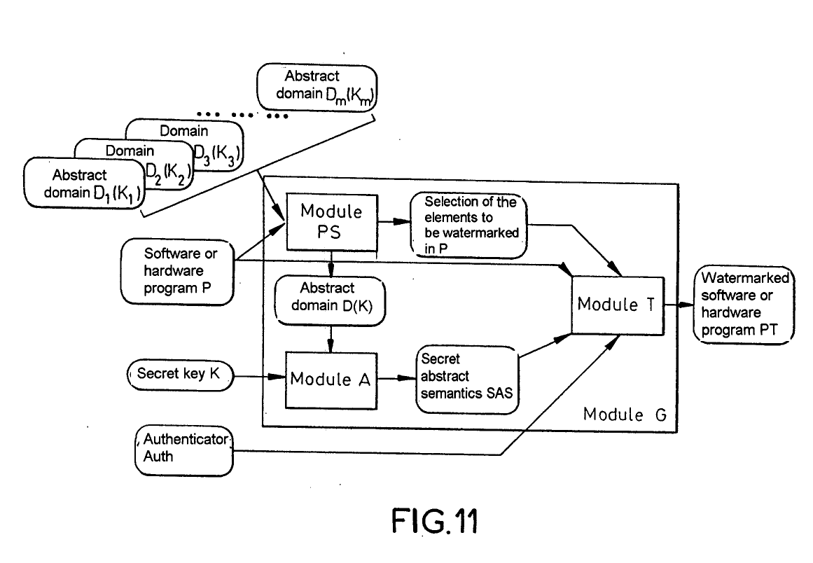

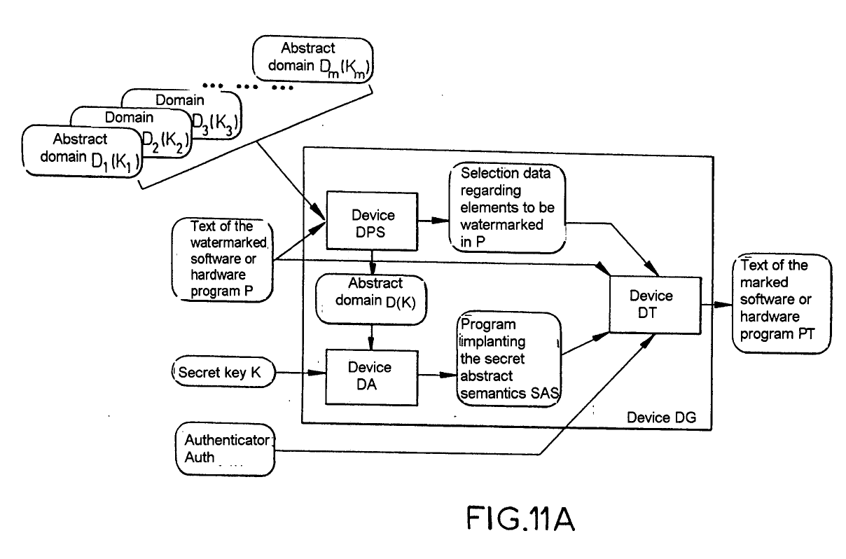

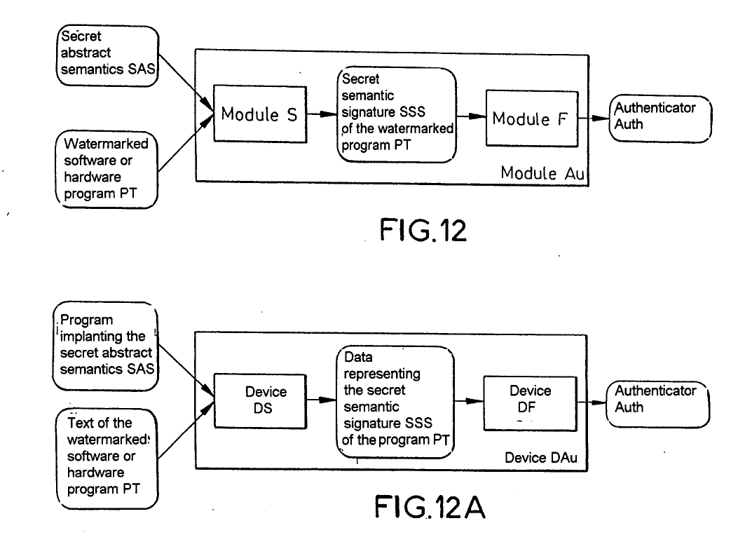

In the exemplary embodiment of FIG. 4, knowledge of the secret number or numbers Nₖ makes it possible by stepwise execution of the program to retrieve from the compiler the variables which comprise a congruence modulo Nₖ at a given instant and then to trace this variable up to its initialization.

The table of secrets can readily be contained on a microprocessor card which will be connected to the computer comprising the interpreter. The authorized user merely has to know a public key which will activate the program for reading the secrets corresponding to his user identification. The private keys which define the table of secrets therefore need not be disclosed.

Two examples given in appendices 2 and 3 make it possible to illustrate the application of semantic static analysis to the authentication of the signature of the software with two simple cases of computing the fixpoints of the hidden variables.

Appendix 4 presents a glossary.

Appendix 5 presents an embodiment of the invention with splitting into finer modules.

Appendix 6 and Appendix 7 present new exemplary embodiments examples 3 and 4).

### APPENDICES

Appendix 1

1.1 Decomposition of the method into 2 blocks A and B of equivalent size.
1.2 For i varying from 1 to p do
1.2.a find a random position in block A
1.2.b form the list of variables having a determined value at this level of execution—2 cases:
   case 1: there are none

Create a variable w initialized to a value x. Insert this initialization between the start of the method and our current position.

case 2: there is at least one

Select one of these variables w, let x be its value at our current position of execution.
1.2.c create any polynomial P of degree 2 satisfying P(x)=cᵢ+k*nᵢ (k small random integer)
1.2.d insert the following initialization instruction: int vᵢ=P(w)
1.2.e find a random position in block B
1.2.f create any polynomial Q of degree 2 satisfying Q(vᵢ)=vᵢ+1*nᵢ (1 small random integer)
1.2.g insert the instruction vᵢ=Q(vᵢ)
   Appendix 2

### EXAMPLE 1

The watermarked method is the main method of the Fibonacci class, which computes the value of the n^{th} term of the Fibonacci series, defined by the

$$relations \{ \begin{matrix}{u}_{n + 2} = {u}_{n + 1} + {u}_{n} \\ {u}_{0} = 0 \\ {u}_{1} = 1\end{matrix}$$

Initial program

```
public class Fibonacci
{
    public Fibonacci ( )
    {
    }
    public static void main(String[] args)
    {
    int n = Integer.parseInt(args[0]);
    int a = 0;
    int b = 1;
    for (int i = 1;i < n;i++)
        {
            int c = a+b;
            a=b; //a equals uᵢ
            b=c; //b equals uᵢ₊₁
            }
        System.out.printIn (“The value of the series
for n=“+n+” is: “+b);
        }
    }
```

Choosing Tables of Semantic Correspondences

We choose to insert two values of mark. To do this we use two transcoding tables.

The first will make it possible to insert the hidden value 2507, the second 3012.

Our two tables associate with each algebraic operation on integers the identical algebraic operation modulo a number N. With each return of an integer value following the call to a method of type int, is associated the initialization to a value V. For the first table, N equals 10 000 and V 17. For the second, N equals 5421 and V equals 50.

1. Transcoding table for 2507

| Initial instruction | Transcoded instruction |
|---|---|
| v (integer) = a (integer) + b | v = a + b modulo 10 000 |
| (integer) | |
| v (integer) = a (integer) * b | v = a * b modulo 10 000 |
| (integer) | |
| v (integer) is the return (integer) | v = 17 |
| from the call to a function | |

2. Transcoding table for 3012

| Initial instruction | Transcoded instruction |
|---|---|
| v (integer) = a (integer) + b | v = a + b modulo 5421 |
| (integer) | |
| v (integer) = a (integer) * b | v = a * b modulo 5421 |
| (integer) | |
| v (integer) is the return (integer) | v = 50 |
| from the call to a function | |

Watermarking of the Method

The watermarking of our method consists in inserting two variables j and k, taking the values 2507 and 3012 respectively in our secret space.

The watermarking consists of two steps:
initialization of j and k as a function of n at the start of the program. This initialization enables us to compute the value of j and k in our conjugate space, on the other hand the values of j and k during the execution of the program are unknown. This enables us to avoid the transformation of these instructions by an optimizer.
addition of instructions into the algorithm ensuring the invariance of j and k in our secret space.

These instructions are computations of j and k with the aid of polynomials of degree 2.

Anchoring of the Mark

The mark is anchored at the end of the method. Specifically, the values of j and k are seemingly used for the computation of the result b. This is a decoy, since the series of operations performed on b ultimately leave this variable invariant.

Watermarked Program

| public class Fibonacci | |
|---|---|
| { | |
| public Fibonacci( ) | |
| { | |
| } | |
| public static void main(String[ ] args) | |
| { | |
| int n=Integer.parseInt(args[0]); | |
| int a=0; | |
| int j=−34*n*n−500*n+833; | // j equals 2507 in |
| | conjugate space No. 1 |
| | //(that is to say modulo |
| | 10 000, n→17) |
| int b=1; | |
| int k=2*n−n*n−9 | // k equals 3012 in |
| | conjugate space No. 2 |
| | (that is to say modulo |
| | 5421, n→50) |

| for (int i=1;i<n;i++) | |
|---|---|
| { | |
| int c=a+b; | |
| a=b; | // a equals u(i) |
| j=j*5−28; | // j still equals 2507 in |
| | conjugate space 1 |
| b=c; | // b equals u(i+1) |
| k=k*k+201; | // k still equals 3012 in |
| | conjugate space 2 |
| } | |

```
    b+=k+j;
    b=b−1−k*j+(1−k)*(1−j); // anchoring of k and j
    System.out.printIn (“The value of the series
for n=“+n+” is: “+b);
        }
    }
```

Analysis of the Mark

The mark is retrieved by Static Analysis, and the method of iterative fixpoint approximation.

The conjugate public static void main (String[ ]args) program in space No. 1 is as follows:

```
    {
        int n=17;
        int a=0;
        int j=(−34*n*n−500*n+833) % 10 000;
        int b=1;
        int k=(2*n−n*n−9) % 10 000;
        for (int i=1;i<n;i++)
            {
                int c=(a+b) % 10 000;
                a=b;
                j=(j*5−28) % 10 000;
                b=c;
                k=(k*k+201) % 10 000;
            }
        b=(b+k+j) % 10 000;
        b=(b−1−k*j+(1−k)*(1−j)) % 10 000;
        System.out.printIn (“The value of the series
        for n=“+n+” is: “+b);
        }
}
```

Let us firstly transform the program into an execution flow graph:

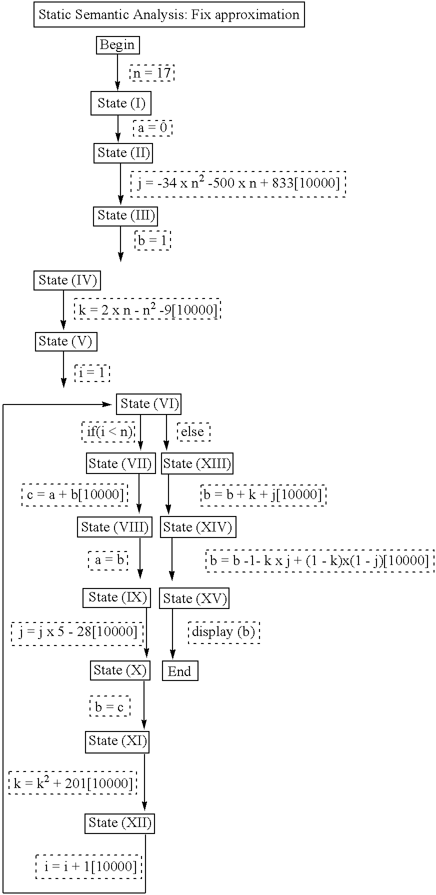

SEMANTIC STATIC ANALYSIS
For each state, we study the set of possible values taken by the
variables. We shall consider only the variables which have changed
value with respect to all the possible previous states.

| | Variable | |
|---|---|---|
| | studied/ | |
| State | Interval | Initial value |
| (I) | n | N_{I} = Ø |
| (II) | a | A_{II} = Ø |
| (III) | j | J_{III} = Ø |
| (IV) | b | B_{IV} = Ø |
| (V) | k | K_{V} = Ø |
| (VI) | i | I_{VI} = Ø |
| (VII) | i | I_{VII} = Ø |
| (VIII) | c | C_{VIII} = Ø |
| (IX) | a | A_{IX} = Ø |
| (X) | j | J_{X} = Ø |
| (XI) | b | B_{XI} = Ø |
| (XII) | k | K_{XII} = Ø |
| (XIII) | i | I_{XIII} = Ø |
| (XIV) | b | B_{XIV} = Ø |
| (XV) | b | B_{XV} = Ø |

$$\{ \begin{matrix}{N}_{I} = \{ 17 \} {A}_{II} = \{ 0 \} {J}_{III} = \{ j = - 34 \times {n}^{2} - 500 \times n + 833 ; n ε {N}_{I} \} \\ {B}_{IV} = \{ 1 \} {K}_{V} = \{ k = 2 \times n - n \times n - 9 ; n ε {N}_{I} \} {I}_{VI} = \{ 1 \} ⋃ ( {I}_{VII} + 1 ) \\ {I}_{VII} = {I}_{VI} ⋃ ] {- ∞ ; supn}_{n ε {N}_{I}} [ \\ {C}_{VIII} = \{ c = a + b ; a ε ( {A}_{II} ⋃ {A}_{IX} ) ⋀ b ε ( {B}_{IV} ⋃ {B}_{XI} ) \} \\ {A}_{IX} = {B}_{IV} ⋃ {B}_{XI} {J}_{X} = \{ j \times 5 - 28 ; j ε ( {J}_{X} ⋃ {J}_{III} ) \} {B}_{XI} = {C}_{VIII} \\ {K}_{XII} = \{ k \times k + 201 ; k ε ( {K}_{V} ⋃ {K}_{XII} ) \} {I}_{XIII} = {I}_{VI} ⋂ [ {inf}_{n ε {N}_{I}} n ; + ∞ [ \\ {B}_{XIV} = \{ b = b + k + j ; \\ b ε ( {B}_{IV} ⋃ {B}_{XI} ) ⋀ k ε ( {K}_{V} ⋃ {K}_{XII} ) ⋀ j ε ( {J}_{III} ⋃ {J}_{X} ) \} \\ {B}_{XV} = \{ b = b - 1 - k \times j + ( 1 - k ) \times * 1 - j ) ; \\ b ε {B}_{XIV} ⋀ k ε ( {K}_{V} ⋃ {K}_{XII} ) ⋀ j ε ( {J}_{III} ⋃ {J}_{X} ) \}\end{matrix}$$

SEMANTIC STATIC ANALYSIS
For each state, we study the set of possible values taken by the
variables. We shall consider only the variables which have changed
value with respect to all the possible previous states. These sets
will be approximated by intervals

| | Iteration number n | | | | |
|---|---|---|---|---|---|
| | 0 | 1 | 2 | 3 | 4 |
| N_{I} | Ø | {17} | {17} | {17} | {17} |
| A_{II} | Ø | {0} | {0} | {0} | {0} |
| J_{III} | Ø | Ø | {2507} | {2507} | {2507} |
| B_{IV} | Ø | {1} | {1} | {1} | {1} |
| K_{V} | Ø | Ø | {9736} | {9736} | {9736} |
| I_{VI} | Ø | {1} | {1} | {1;2} | {1;2} |
| I_{VII} | Ø | Ø | {1} | {1} | {1;2} |
| C_{VIII} | Ø | Ø | {1} | {1;2} | {1;2} |
| A_{IX} | Ø | Ø | {1} | {1} | {1} |
| J_{X} | Ø | Ø | Ø | {2507} | {2507} |
| B_{XI} | Ø | Ø | Ø | {1} | {1;2} |
| K_{XII} | Ø | Ø | Ø | {9897} | {82;9930} |
| I_{XIII} | Ø | Ø | Ø | Ø | Ø |
| B_{IV} | Ø | Ø | Ø | {2244} | {2244;2405} |
| B_{XV} | Ø | Ø | Ø | Ø | {0;9999} |
| | Iteration number n | | | | |
| | | | | | 35 |
| | 5 | 6 | 7 | 8 | FIXPOINT |
| N_{I} | {17} | {17} | {17} | {17} | {17} |
| A_{II} | {0} | {0} | {0} | {0} | {0} |
| J_{III} | {2507} | {2507} | {2507} | {2507} | {2507} |
| B_{IV} | {1} | {1} | {1} | {1} | {1} |
| K_{V} | {9736} | {9736} | {9736} | {9736} | {9736} |
| I_{VI} | {1;3} | {1;3} | {1;4} | {1;4} | {1;17} |
| I_{VII} | {1;2} | {1;3} | {1;3} | {1;4} | {1;16} |
| C_{VIII} | {1;3} | {1;4} | {1;5} | {1;7} | {0;9999} |
| A_{IX} | {1;2} | {1;2} | {1;3} | {1;4} | {0;9999} |
| J_{X} | {2507} | {2507} | {2507} | {2507} | {2507} |
| B_{XI} | {1;2} | {1;3} | {1;4} | {1;5} | {1;9999} |
| K_{XII} | {2;9997} | {2;9997} | {2;9997} | {2;9997} | {2;9997} |
| I_{XIII} | Ø | Ø | Ø | Ø | Ø |
| B_{XIV} | {0;9999} | {0;9999} | {0;9999} | {0;9999} | {0;9999} |
| B_{XV} | {0;9999} | {0;9999} | {0;9999} | {0;9999} | {0;9999} |

We encounter our first mark: the variable J always retains the value 2507.

The conjugated program in space No. 2 is as follows:

```
    public static void main(Stringt[] args)
    {
        int n=50;
        int a=0;
        int j=(−34*n*n−500*n+833) % 5421;
        int b=1;
        int k=(2*n−n*n−9) % 5421;
        for (int i=1;i<n;i++)
            {
                int c=(a+b) % 5421;
                a=b;
                j=(j*5−28) % 5421;
                b=c;
                k=(k*k+201) % 5421;
            }
        b=(b+k+j) % 5421;
        b=(b−1−k*j+(1−k)*(1−j)) % 5421;
        System.out.printIn(The value of the series for n=“+n+” is :
“+b);
    }
```

As before, let us transform the program into an execution flow graph:

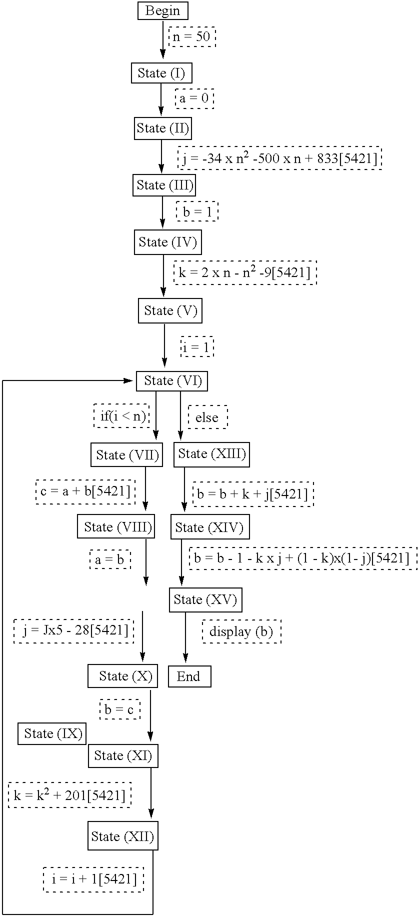

SEMANTIC STATIC ANALYSIS
For each state, we study the set of possible values taken by the
variables. We shall consider only the variables which have changed value
with respect to all the possible previous states.

| | Variable | |
|---|---|---|
| | studied/ | |
| State | Interval | Initial value |
| (I) | n | N_{I} = Ø |
| (II) | a | A_{II} = Ø |
| (III) | j | J_{III} = Ø |
| (IV) | b | B_{IV} = Ø |
| (V) | k | K_{V} = Ø |
| (VI) | i | I_{VI} = Ø |
| (VII) | i | I_{VII} = Ø |
| (VIII) | c | C_{VIII} = Ø |
| (IX) | a | A_{IX} = Ø |
| (X) | j | J_{X} = Ø |
| (XI) | b | B_{XI} = Ø |
| (XII) | k | K_{XII} = Ø |
| (XIII) | i | I_{XIII} = Ø |
| (XIV) | b | B_{XIV} = Ø |
| (XV) | b | B_{XV} = Ø |

$$\{ \begin{matrix}{N}_{I} = \{ 50 \} {A}_{II} = \{ 0 \} {J}_{III} = \{ j = - 34 \times {n}^{2} - 500 \times n + 833 ; n ε {N}_{I} \} \\ {B}_{IV} = \{ 1 \} {K}_{V} = \{ k = 2 \times n - n \times n - 9 ; n ε {N}_{I} \} {I}_{VI} = \{ 1 \} ⋃ ( {I}_{VII} + 1 ) \\ {I}_{VII} = {I}_{VI} ⋃ ] {- ∞ ; supn}_{n ε {N}_{I}} [ \\ {C}_{VIII} = \{ c = a + b ; a ε ( {A}_{II} ⋃ {A}_{IX} ) ⋀ b ε ( {B}_{IV} ⋃ {B}_{XI} ) \} \\ {A}_{IX} = {B}_{IV} ⋃ {B}_{XI} {J}_{X} = \{ j \times 5 - 28 ; j ε ( {J}_{X} ⋃ {J}_{III} ) \} {B}_{XI} = {C}_{VIII} \\ {K}_{XII} = \{ k \times k + 201 ; k ε ( {K}_{V} ⋃ {K}_{XII} ) \} {I}_{XIII} = {I}_{VI} ⋂ [ {inf}_{n ε {N}_{I}} n ; + ∞ [ \\ {B}_{XIV} = \{ b = b + k + j ; \\ b ε ( {B}_{IV} ⋃ {B}_{XI} ) ⋀ k ε ( {K}_{V} ⋃ {K}_{XII} ) ⋀ j ε ( {J}_{III} ⋃ {J}_{X} ) \} \\ {B}_{XV} = \{ b = b - 1 - k \times j + ( 1 - k ) \times * 1 - j ) ; \\ b ε {B}_{XIV} ⋀ k ε ( {K}_{V} ⋃ {K}_{XII} ) ⋀ j ε ( {J}_{III} ⋃ {J}_{X} ) \}\end{matrix}$$

SEMANTIC STATIC ANALYSIS
For each state, we study the set of possible values taken by the variables.
We shall consider only the variables which have changed value with
respect to all the possible previous states. These sets will be
approximated by intervals

| | Iteration number | | | | |
|---|---|---|---|---|---|
| | 0 | 1 | 2 | 3 | 4 |
| N_{I} | Ø | {50} | {50} | {50} | {50} |
| A_{II} | Ø | {0} | {0} | {0} | {0} |
| J_{III} | Ø | Ø | {4674} | {4674} | {4674} |
| B_{IV} | Ø | {1} | {1} | {1} | {1} |
| K_{V} | Ø | Ø | {3012} | {3012} | {3012} |
| I_{VI} | Ø | {1} | {1} | {1;2} | {1;2} |
| I_{VII} | Ø | Ø | {1} | {1} | {1;2} |
| C_{VIII} | Ø | Ø | {1} | {1;2} | {1;2} |
| A_{IX} | Ø | Ø | {1} | {1} | {1} |
| J_{X} | Ø | Ø | Ø | {1658} | {0;5420} |
| B_{XI} | Ø | Ø | Ø | {1} | {1;2} |
| K_{XII} | Ø | Ø | Ø | {3012} | {3012} |
| I_{XIII} | Ø | Ø | Ø | Ø | Ø |
| B_{XIV} | Ø | Ø | Ø | {2266} | {0;4671} |
| B_{XV} | Ø | Ø | Ø | Ø | {0;5420} |
| | Iteration number | | | | |
| | | | | | 105 |
| | 5 | 6 | 7 | 8 | FIXPOINT |
| N_{I} | {50} | {50} | {50} | {50} | {50} |
| A_{II} | {0} | {0} | {0} | {0} | {0} |
| J_{III} | {4674} | {4674} | {4674} | {4674} | {4674} |
| B_{IV} | {1} | {1} | {1} | {1} | {1} |
| K_{V} | {3012} | {3012} | {3012} | {3012} | {3012} |
| I_{VI} | {1;3} | {1;3} | {1;4} | {1;4} | {1;50} |
| I_{VII} | {1;2} | {1;3} | {1;3} | {1;4} | {1;49} |
| C_{VIII} | {1;3} | {1;4} | {1;5} | {1;7} | {0;5421} |
| A_{IX} | {1;2} | {1;2} | {1;3} | {1;4} | {0;5421} |
| J_{X} | {0;5420} | {0;5420} | {0;5420} | {0;5420} | {0;5420} |
| B_{XI} | {1;2} | {1;3} | {1;4} | {1;5} | {0;5420} |
| K_{XII} | {3012} | {3012} | {3012} | {3012} | {3012} |
| I_{XIII} | Ø | Ø | Ø | Ø | {50} |
| B_{XIV} | {0;5420} | {0;5420} | {0;5420} | {0;5420} | {0;5420} |
| B_{XV} | {0;5420} | {0;5420} | {0;5420} | {0;5420} | {0;5420} |

We Encounter our Second Mark: 3012.
Annex 3

### Example 2

The method whose semantic signature is extracted is a bubble sort method.

Initial Program

```
public class Bubble
{
public static void main(String[ ] args)
  {
    int[ ] table=new int[args.length];
    for (int i=0;i<args.length;i++)
      table[i]=Integer.parseInt(args[i]);
    print(table);
    print(sort(table));
  }
  public static void print(int[ ] table)
  {
    System.out.printIn(“”);
    for (int i=0;i<table.length;i++)
      System.out.print(table[i]+“ ”);
    System.out.printIn(“”);
  }
  public static int[ ] tri(int[ ] table)
  {
    int[ ] table2=table;
    boolean flag=false;
    int i=0;
    int v=0;
    while(!flag)
    {
      flag=true;
      for (i=0;i<table2.length−1;i++)
        {
          if (table2[i]>table2[i+1])
            {
              v=table2[i];
              table2[i]=table2[i+1];
              table2[i+1]=v;
              flag=false;
            }
        }
    }
    return(table2);
  }
}
```

Choosing a Semantic Correspondence Table

We wish to obtain a semantic property after transcoding. To do this we use a transcoding table.

For the variables of our conjugate space, we shall supplement the variables of our initial space with two new variables W and W′ of integer type which are initialized with the value 0.

Thereafter we try to locate the transpositions performed on the arrays of the program, and we shall replace these operations performed on the array by operations on the variable W. A static analysis on W will show that it retains a constant value equal to 1 in all situations.

Transcoding table

| Initial instruction | Transcoded instruction |
|---|---|
| Start of program | W equals 0 |
| | W′ equals 0 |
| Sequence: | Sequence: |
| <sequence of arbitrary operations (1)> | <series of operations (1)> |
| <a variable X takes the value of | <series of operations (2)> |
| an array T at the index P> | <series of operations (3)> |
| <series of arbitrary operations (2) | <series of operations (4)> |
| affecting neither X nor T nor P> | <series of operations (5)> |
| <a variable Y takes the value of | If W = 0 Then W = 1 |
| T at an index Q> | W = W*absolute value (P- |
| <series of arbitrary operations | Q) |
| (3) affecting neither X, nor Y, | W′ = min(P,Q) |
| nor T, nor P, nor Q> | |
| The value of Y is written at the | |
| index P of T> | |
| <series of arbitrary operations (4) | |
| affecting neither X nor T nor Q> | |
| <the value of X is written at | |
| the index Q of T> | |
| <series of arbitrary operations (5)> | |
| T is an array, input parameter | T is the array (5; 2; 4; 1; 3) |

Signature of the Method

The signature of the method consists of the semantic static analysis of the method and the detection of properties.

Analysis of the Program

The properties are retrieved by Static Analysis, and the iterative fixed point approximation method.

The execution graph for the conjugate program is as follows:

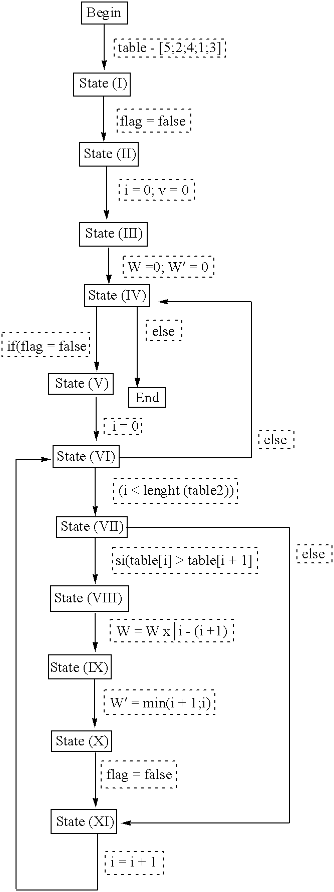

$$\{ \begin{matrix}{TABLE}_{I} = \{ [ 5 ; 2 ; 4 ; 1 ; 3 ] \} \\ {FLAG}_{II} = \{ false \} \\ \{ \begin{matrix}{I}_{III} = \{ 0 \} \\ {V}_{III} = \{ 0 \}\end{matrix} \{ \begin{matrix}{W}_{IV} = \{ 0 \} \\ {W}_{IV}^{′} = \{ 0 \}\end{matrix} \\ {FLAG}_{V} = {FLAG}_{II} ⋂ \{ false \} \\ {I}_{VI} = \{ 0 \} ⋃ ( {I}_{VIII} ⊕ 1 ) \\ {I}_{VII} = {I}_{VI} ⋂ ] - ∞ ; length ( {table}_{II} ) [ \\ \{ \begin{matrix}{TABLE}_{VIII} = \{ table ε ( {TABLE}_{II} ⋃ {TABLE}_{VIII} ) such that \\ ∃ i ε {I}_{VII} such that table ( i ) > table ( i + 1 ) \} \\ {I}_{VIII} = \{ i ε {I}_{VII} such that \\ ∃ table ε ( {TABLE}_{II} ⋃ {TABLE}_{VIII} ) such that \\ table ( i ) > table ( i + 1 ) \}\end{matrix} \\ {W}_{IX} = {⋃}_{w ε ( {W}_{IX} ⋃ {W}_{IV} )} f ( w ) ; f \text{:} \vert \begin{matrix}0 \vert \to \{ 1 \} \\ x \neq 0 \vert \to \{ x \times \vert i - ( i + 1 ) ; i ε {I}_{VIII} \}\end{matrix} \\ {W}_{X}^{′} = \{ min ( i + 1 ; i ) ; i ε {I}_{VIII} \} \\ {FLAG}_{XI} = \{ false \}\end{matrix}$$

| Iterations | 0 | 1 | 2 |
|---|---|---|---|
| FLAG_{V} | Ø | {false} | {false} |
| I_{VI} | Ø | {0} | {0;1} |
| I_{VII} | Ø | {0} | {0;1} |
| TABLE_{VIII} | Ø | {(5;2;4;1;3)} | {(5;2;4;1;3)} |
| I_{VIII} | Ø | {0} | {0} |
| W_{IX} | Ø | {1} | {1} |
| W′_{X} | Ø | {0} | {0} |
| FLAG_{XI} | Ø | {false} | {false} |

| Iterations | 3 | 4 | 5 - FIXPOINT |
|---|---|---|---|
| FLAG_{V} | {false} | {false} | {false} |
| I_{VI} | {0;1;2} | {0;1;2;3} | {0;1;2;3;4} |
| I_{VII} | {0;1;2} | {0;1;2;3} | {0;1;2;3} |
| TABLE_{VIII} | {(5;2;4;1;3)} | {(5;2;4;1;3)} | {(5;2;4;1;3)} |
| I_{VIII} | {0;2} | {0;2} | {0;2} |
| W_{IX} | {1} | {1} | {1} |
| W′_{X} | {0;2} | {0;2} | {0;2} |
| FLAG_{XI} | {false} | {false} | {false} |

Signature:

We note the signature of our bubble sort method:

By considering the secret transcoding table, we note that:
“the associated variable W retains a constant value equal to 1”
“our variable X′ takes the values 0 and 2”.
   Appendix 4
   Glossary

A software or hardware protection/prevention process is a set of techniques which render the copying and fraudulent use of the software or electronic circuits more difficult.

A program is written in a certain programming language called the computer language of the program.

The interpretation of a program is the translation of the series of words of which it is composed into a series of actions which is called the execution of the program.

The compilation of a source program, written in a high-level language, is its translation into another language or embodiment as an automaton, as general machine language or electronic circuit.

A software computer program is an interpretable program or one which can be compiled into an interpretable program.

A hardware computer program is a program which can be carried out by an electronic circuit and is specified by a circuit description language.

An element of a computer program is a not necessarily connected part of the text of the program corresponding to one or more instructions, possibly compound instructions (such as a conditional-choice or case-based command, a loop, etc.), a declaration or description of one or more data structures possibly comprising the or some of the operations acting on these data structures, one or more procedures or methods, one or more modules, etc.

A semantics of a software or hardware program is a mathematical model defining the set of possible behaviors of a program upon execution at a certain level of observation.

Semantic static analysis is the automatic determination of semantic properties of the programs.

Two software programs are semantically equivalent (or functionally equivalent) if they have the same observable behavior, that is to say if they execute in a functionally equivalent manner, (for example, if for every possible input, the outputs of the program are the same).

An abstract semantics of a software or hardware program is a mathematical model defining an over-approximation or an under-approximation of the set of possible behaviors of a program upon execution.

An abstract semantics is secret if its specification for a software or hardware program requires knowledge of a secret.

A signature is a characteristic item of information (tag, label or summary) associated with an object (here, a software or hardware program). This item of information may depend on an intrinsic or extrinsic property of the object. These properties can authenticate the form and background of the content of the object (coding, format, syntax, esthetics, semantics) or its traceability (history and/or future of this object)

A secret signature is a signature obtained with the aid of the method calling upon a secret.

A semantic signature is a signature-specified as a function of the semantics of the object (here, of the program written in a programming language, with defined semantics).

An authenticator is a secret proof of the possession of an item of information or of a right (for example designation of the object, name of the author, name of the recipient, terms of the license of use, etc.).

A mark is a component of an object which enables it to be identified and which, within the context of the invention, makes it possible to retrieve a signature of the object.

The tagging of an object or of a program consists in fabricating a tag which is in general separate from the content of the object or inlaid into the object at an easily locatable place.

In contradistinction, watermarking consists in inlaying a (or several) mark(s) into the body of the object. This mark dispersed within the body of the object is in general if not indiscernible at least indelible. The object grafted with this mark is called the watermarked object.

Obfuscation is the transformation of a program into a semantically equivalent program in a form which is difficult for a computer scientist to understand but can be used by a user. In contradistinction to watermarking, obfuscation renders a program confidential (by virtue of the difficulty in understanding it) but does not allow authentication [cf. Obfuscation techniques for enhancing software security, New Zealand Patent Application #328057, WO 99/01815, PCT/US98/12017, Jun. 9, 1997].

The washing of a mark is an attempt to erase or to modify the mark or else an overloading of the program so as to drown the mark, without changing the semantics of the program.

A program watermark is robust if it is resistant to compilation optimization, obfuscation, tagging and to another watermark, all these operations being applied subsequently.

Appendix 5

### Analytical Description of the Modules and Theoretical Background

An Abstract Semantics Process A

The inventor uses the principles and techniques of semantic static analysis of programs by abstract interpretation, cf. [P. Cousot & R. Cousot, “Abstract Interpretation: A unified lattice model for static analysis of programs by construction or approximation of fixpoints”, International Conference “Principles of programming languages, POPL'77”, p. 238-252, ACM Press, January 1977] and [P. Cousot & R. Cousot, “Systematic design of program analysis frameworks”, International Conference “Principles of programming languages, POPL'77”, p. 269-282, ACM Press, January 1979].

The process/module A defines an infinity of secret abstract semantics dependent:
on an abstract domain D(K) parameterized by a secret key K (which, to within an injection, may be regarded as a number N=b(K), this injection b possibly itself constituting a secret);
on a particular secret key K which defines the abstract domain D(K) used in the secret abstract semantics SAS.

This secret abstract semantics SAS consists of the secret abstract domain D(N) and of the corresponding abstract operations for the constructions and primitives of the family of programming languages considered, which are obtained by using the principles of abstract interpretation.

Any abstract domain D(K) obtained by abstraction, in the sense of the theory of abstract interpretation, cf. [P. Cousot & R. Cousot, “Abstract Interpretation: A unified lattice model for static analysis of programs by construction or approximation of fixpoints”, International Conference “Principles of programming languages, POPL'77”, p. 238-252, ACM Press, January 1977] and [P. Cousot & R. Cousot, “Systematic design of program analysis frameworks”, International Conference “Principles of programming languages, POPL'77, p. 269-282, ACM Press, January 1979], parameterized by a secret key K can be used as parameter for the module A. By virtue of the use of an injection N=b(K), which may remain secret, any abstract domain D(N), parameterized by a number N, can be reused with any keys. There is therefore an infinity of abstract domains D(K), parameterized by a key K, which can be used. However, the abstract domains published in the scientific literature are not suitable, in the sense that they are not parameterized by a key K (even one chosen in a manner which is isomorphic to the integers or to the ordinals).

A part of the invention is the transformation of any abstract domain which can be used for classical static semantic analysis, the concrete expression of which provides an item of information regarding integer values (to within an injective coding) into an abstract domain D(N) parameterized by an integer N constituting the secret key K=N (to within said coding). The process consists in abstracting (in the sense of abstract interpretation) concrete operations into an abstract operation considering the concrete operation carried out modulo N. This abstraction is then extended to the elements for controlling the program according to the principles of semantic static analysis by abstract interpretation, possibly using the techniques of widening and of narrowing which are known to the person skilled in the art.

Examples of transforming such domains D into domains D(N) are described below:
for a program P written in algorithmic language (with additions, multiplications, loops, branchings, etc.) and whose author wishes to secure the sensitive algorithmic content, it is possible to define, for the module A, an abstract domain D(K) for the integer variables or fixed-point or floating-point variables, or even the reals corresponding to the propagation of constants, to powers, to intervals, to octagons, to linear invariants of equality or of inequality, etc., modulo a positive integer value N constituting the secret key K=N;
for a program P written in programming language with symbolic data (with pointers, lists, arrays, etc.), and whose author wishes to secure the sensitive business of manipulating variables and arrays, it is possible to use a symbolic abstract domain (for example an automaton or tree domains) parameterized by integers (for example counters of loops in the automaton or a measure of the size of the symbolic data) by reusing the previous abstract domain D(N) to analyze the integer parameters, modulo a positive integer value N constituting the secret key K, again to within an injection (which may be secret).

There is on the one hand an infinity of possible abstract domains Di and on the other hand an infinity of instances Di(K) of each particular domain as a function of the secret key K.

In contradistinction to conventional cryptology, if the module A is secret, it is inconceivable to break it by brute force. Indeed, there is no possible enumeration of all the usable parameterized abstract domains.

For a given secret abstract domain Di(N), different keys lead to different secret abstract semantics SAS, as is the case for the examples above. When the secret abstract domain has been disclosed or is public, the secret of the key must be managed as in conventional cryptography so as to limit the attacks to brute force (as in the case of conventional cryptology based on NP-complete problems or secret-key enciphering mechanisms).

The secret abstract semantics SAS must be invariant for the transformations of the primitives and constructions of the family of software or hardware languages considered, which leave their standard semantics invariant, as is the case for the examples above. This is important in order to avoid obfuscation attacks which consist in transforming a program P into a syntactically different but semantically equivalent program, for example, the mathematical expression (a=2b) being changed into (a=b+b).

(See FIG. 5).

An Abstract Semantics Module DA

Among the preferred embodiments of the above process, the invention also discloses a device (which can be embodied as a computer product/program) which includes:

A module DA based on an abstract domain Dᵢ(K) parameterized by a secret key K chosen from a very large possible number, making it possible to generate a program implanting the secret abstract semantics SAS of the family of software or hardware programming languages considered:

(See FIG. 5A)

A Signature Process S

The process/module S uses a secret abstract semantics SAS for the constructions and primitives of the family of programming languages considered, to carry out the semantic static analysis of the original software or hardware program P, the result of this analysis providing the secret semantic signature SSS of the program P. To do this, the module S constructs a representation of the system of fixpoint equations whose approximate solution defines the abstract semantics SASP of said software or hardware program P. This abstract semantics SASP of the software or hardware program P is defined according to the principles of static analysis by abstract interpretation of the concrete semantics of the program as a function of the secret abstract semantics SAS for the constructions and primitives of the family of programming languages considered. This abstract semantics SASP is computed by elimination, or by iteration with acceleration of convergence. The secret semantic signature SSS of the program P is an injective function SSS=i(SASP) of the secret abstract semantics SASP. This injective function i can itself constitute a secret.

The secret semantic signature SSS of a software or hardware program P, computed according to the module S or by the device DS makes it possible to verify whether a software or hardware program P′ has an equivalent semantic signature.

At this juncture, it is possible to deposit the signature SSS of the software or hardware program P such as this signature was produced according to the module S or output by the device DS with a Trusted Third Party (TTP). It therefore does not have to be inserted into the software or hardware program P. Authentication of the software or hardware program P will then be performed by the TTP by comparing the signature produced SSS′ of the software or hardware program P′ to be analyzed with the signature (SSS) which was deposited. In this case, the software or hardware program P is not protected against copying P′, but two cases arise:
SSS′ is different from SSS: the modifications which P has undergone are detectable, since in the case of semantic modifications (for example, addition of a virus, modification of an algorithm), the signature is different;
SSS′ is equal to SSS: the software or hardware program P′ is a copy of P or if the software or hardware program P has been obfuscated (manually or automatically) so as to become P′, the signature SSS′ of P′ will be equal to that SSS of P, and this will prove, with an extremely small probability of error, that the software or hardware program P has been pirated, this pirating being masked by doctoring.
   (See FIG. 6)
   A Signature Module DS

A module DS making it possible to compute the signature SSS of a software or hardware program P according to the secret abstract semantics SAS obtained by using the previous module DA.

(See FIG. 6A)

A Marking Process M

In respect of the invention, a mark m is a software or hardware program element which can be inserted into a software or hardware program by the process described in the module B hereinbelow. Let Pm be the simplest possible software or hardware program into which the mark m can be inserted. For any secret abstract semantics SAS, this program Pm has a secret semantic signature, which is computable by the module S, the so-called secret semantic signature of said mark m and denoted SSS(m).

A “mark” m is a triple consisting of a “mark location”, an “initialization mark” and an “induction mark”, one of the last two possibly being empty.

Let Pm be the simplest possible software or hardware program of the language family considered, which declares if necessary the “mark location” ‘X’, executes the “initialization mark” ‘The’, then executes the “induction mark” ‘If’ one or more or even an infinite number of times.

The marking process M is parameterized by a secret abstract semantics SAS (for example, produced by the module A from an abstract domain Di(K) as a function of a secret key K) and a secret semantic signature SSS;

By using a bijection β which may be secret, the module M computes an abstract value ‘s’ of the abstract domain Di(K) as a function of the secret semantic signature SSS, according to the coding of the secret abstract semantics SAS. This abstract value ‘s’ is chosen in such a way that there exist very numerous concrete values ‘x’ whose abstraction according to the principles of abstract interpretation or that of the singleton ‘{x}’ is the abstract value ‘s’. For example this value ‘x’ may be that of a variable in the case of a nonrelational analysis or of a vector of variables for a relational analysis or the value of any object analogous to a vector of variables;

The process M chooses, according to the principles of abstract interpretation, any one of the concrete values ‘a’ whose abstraction or that of the singleton ‘{a}’ is the abstract value s;

The process M then chooses, according to the principles of abstract interpretation, a concrete operation ‘f’ whose functional abstraction leaves the abstract value ‘s’ invariant but not the corresponding concrete values (that is to say if ‘x’ is a concrete value whose abstraction according to the principles of abstract interpretation or that of the singleton ‘{x}’ is the abstract value ‘s’ then ‘f(x)’ is in general different from ‘x’ whereas the abstraction according to the principles of abstract interpretation of ‘f(x)’ or that of the singleton ‘{f(x)}’ is equal to ‘s’);

The process M then chooses a “mark location” ‘X’ which may be an existing variable of the program and which is unnecessary or which is not live in the elements of the program P to be watermarked, a new auxiliary variable, an unnecessary or additional field of a dynamically allotted data structure, etc. whose values are taken into account in the semantic static analysis used to determine the secret abstract semantics of the program;

The process M then determines an “initalization mark” ‘the’ which consists of one or more primitives or constructions of the family of languages considered and interpreted as an assignment of the concrete value ‘a’ defined hereinabove to the mark location ‘X’;

The process M then determines an “induction mark” ‘If’ comprising one or more primitives or constructions of the family of languages considered and interpreted as an assignment of the value of ‘f(X)’ to the mark location ‘X’. Depending on the family of languages considered, these primitives or constructions will be assignments, parameter passes, unifications, etc.

The mark m is chosen such that, according to the principles of abstract interpretation, the static semantic analysis of the program Pm, according to the secret abstract semantics and in accordance with the directives of the module S, determines in a manner which is recognizable by the possessor of the secret SAS, the abstract value ‘s’ defined hereinabove and such that the secret semantic signature of the program Pm, as defined hereinabove, is that SSS(m) of the mark.

By using abstract domains which are Cartesian products or reduced products of elementary abstract domains, it is always possible to consider the marks which are finite sets of elementary marks.

(See FIG. 7)

A Marking Module DM

Among the preferred embodiments of the above process M, the invention also discloses a device DM (which may be embodied as a computer product/program) which, on the basis of the program implanting the secret abstract semantics SAS and data representing the secret semantics SSS of the program P, computes the text of the mark m.

(See FIG. 7A)

A Camouflaging Process B

The camouflaging process/module B takes as parameter the original software or hardware program P, a selection of the elements of the program P to be watermarked and a mark m. The module B provides the watermarked program PT which is a merger of the original program P and of the mark m. This merger is effected without impairing the secret abstract semantics of the mark, or the functionality of the original program, thereby making it possible to retrieve the secret semantic signature SSS(m) of the mark m from the secret semantic signature SSS(PT) of the watermarked program PT.

It is important to note that, in the preferred embodiment of the invention, the observation of the values taken by the variables during the execution of the watermarked software or hardware program PT does not make it possible to retrieve the mark. On the one hand, it is necessary to know the secret abstract semantics in order to establish the watermarked program PT. On the other hand, the computation of semantic properties of this watermarked software or hardware program PT may be effected, in cases of nontrivial abstract domains D(K), only by static semantic analysis, and not by stepwise execution.

The insertion of the instructions into the software or hardware program to be protected P must comply with a certain number of minimum rules of robustness. For example, to preclude straightforward deletion by an optimizer using “slicing” extraction techniques, it is necessary to ensure that the variables and the operations containing the watermarks give the impression that they have a possible influence on the observable semantics (for example the outputs) of the program. Said potential dependence may be a simple syntactic dependence chosen in such a way that demonstration that this syntactic dependence does not entail a semantic dependence requires the complex proof of a semantic equivalence of software or hardware programs. Such is the case for example for the dynamic value allocation (semantically unnecessary but this is undecidable) of certain values computed by the operations containing the watermarks.

The mark m created by the module M, the selection of elements to be watermarked in a software or hardware program P, this selection being as chosen by the module, PS and used by the module B, must satisfy the criteria stated hereinbelow.

The “induction marks” ‘if’ must be included in the parts of the software or hardware program containing repetition primitives or constructions (iterations, recursivities, etc.).

The “initialization marks” ‘the’ are used to effect the initializations required by the semantics of the family of languages considered. Moreover, if necessary, for the language family considered, any declarations must be added to the watermarked program PT if the nature of the “mark location” ‘X’ so requires.

Finally, the camouflaging module B adds primitives or constructions to the watermarked program PT which activate the values which may be used in the “mark locations” ‘X’. One possible solution consists in using the values which may be used in the “mark locations” in the computation of active variables of the watermarked hardware or software program PT, or else in assigning the values of the “mark locations” ‘X’ to dynamic variables of the watermarked program PT, more generally by ensuring that the dynamic lifetime of the “mark locations” ‘X’ is that of the watermarked program PT. Once again these transformations of the program P into the watermarked program PT must be effected without impairing the secret abstract semantics of the mark, or the functionality of the original program, in such a way, according to the principles of static analysis by abstract interpretation, that this makes it possible to retrieve the secret semantic signature SSS(m) of the mark m from the secret semantic signature SSS(PT) of the watermarked program PT.

(See FIG. 8)

A Camouflaging Module DB

Among the preferred embodiments of the above process B, the invention also discloses a device DB (which may be embodied as a computer product/program) which, on the basis of the text of the software or hardware program P, of data regarding selection of the elements to be watermarked in P and of the text of the mark m, produces the text of the software or hardware program PT whose semantics are functionally equivalent to those of P and which conceals the mark m.

(See FIG. 8A)

A Security Policy Process PS

The process PS for selecting the watermark abstract domain and the elements to be watermarked in the software or hardware program P depends on the security policy to be applied to this program P:

Just as with steganographic techniques, the mark can be dispersed within the program at various remote places by choosing for example static semantic analyses by abstract interpretation which are based on abstract domains making it possible to ignore the control structures in the computation of the secret semantic signature so that the random dispersion of the marks has no effect on this analysis; this strategy is applicable for example when the mark serves to authenticate any program P, of relatively large size.

Another security policy consists in watermarking the innovative and/or sensitive parts of the program P. In general the elements selected for watermarking relate to the algorithmic part of the program (algebraic operations or manipulations of variables in random access memory). Depending on the family of programming languages considered and the programming methodology used, this algorithmic part may be:
significant elements of the program which are semantically autonomous. In Java™ for example, a program is likened to several classes composed of several methods, which may themselves call upon methods from other classes and other packages. A security policy for Java™ can therefore consist in watermarking the methods which are the smallest significant autonomous entities of the program. Another choice would be to watermark Beans™.
elements dispersed within the program constituting a semantically consistent set such as for example an algebraic abstract type which would be implemented by data structures and procedures and functions dispersed throughout the program;

In this case the elements to be watermarked can be selected automatically via syntactic criteria (procedures, modules, etc.) or semantic criteria (through static analysis of dependency) or manually by operator intervention.

Several different security policies may be implemented on the same program P by repeating successful watermarkings of the same original software or hardware program for different parties. Several levels of a hardware or software distribution chain (purchaser, wholesaler, distributor, retailer) can thus be assigned marks specific to them. A software or hardware program can thus be watermarked as often as desired (superposition of watermarks), in contradistinction to the watermarking of sounds or pictures which undergo a certain saturation of the subliminal channel (depending on the perception model chosen). The software or hardware program will not be impaired, it will be overloaded, the memory and temporal resources alone will be affected.

Different secret semantics can be used for each of these watermarks, so that the chain of trust can have different secrets.

Of course, this device and this watermarking process can be combined with devices and processes of the prior art in order to render the software or hardware program unusable to an unauthorized user (prevention) in order to trace the possible dissemination of said program by an authorized user to unauthorized users (audit). To do this it will suffice for the keys enabling authorized users to retrieve the watermark not to be communicated to them.

The device and the process can also be used to automatically authenticate the software or hardware programs which will be authorized to travel over a network or to be hosted on a given computing station. The watermark can be likened to an authentication certificate whose station for monitoring the network or computing station will be furnished with the reading key.

(See FIG. 9)

A Security Policy Module DPS

Among the preferred embodiments of the above process PS, the invention also discloses a device DPS (which can be embodied as a computer product/program) which, on the basis of the text of the software or hardware program P and of a family of abstract domains D₁, . . . , Dₘ, chooses an abstract domain D and selects the elements of the program P to be watermarked.

(See FIG. 9A)

A Watermarking Process T

The watermarking process T uses an enciphering module C which implants a bijective function for calculating a secret semantic signature SSS as a function of an authenticator Auth, possibly by using the secret abstract semantics SAS. From this secret semantic signature SSS and said secret abstract semantics SAS, the marking module M described hereinabove produces a mark m. The module T again uses the module B described hereinabove which, on the basis of said mark m, of the software or hardware program P and of the selection of elements to be watermarked in P provides the watermarked software or hardware program PT.

(See FIG. 10)

A Watermarking Module DT

Among the preferred embodiments of the above watermarking process T, the invention also discloses a device DT (which may be embodied as a computer product/program) for concealing an authenticator Auth in the text of an original software or hardware program P by virtue of a program implanting a secret abstract semantics SAS and data regarding selection of the elements of P to be watermarked.

(See FIG. 10A)

A General Process G

The general process G serves to watermark a program P. To do this, the module PS described above is used to automatically or interactively choose the parameterized abstract domain which will subsequently be used to carry out the static analysis by abstract interpretation by the authentication module Au and also to automatically or interactively select the elements of the software or hardware program to be watermarked P. Next, the module A described above is used to compute the secret abstract semantics SAS on the basis of the previously selected parameterized abstract domain and of a secret key, in general chosen under interaction with an operator but which may also be chosen automatically, or even randomly. Finally, the module T described above uses the program P, the secret abstract semantics SAS, an authenticator Auth and the selection of elements to be watermarked in P to produce the watermarked software or hardware program PT. Variants consist in fixing once and for all the abstract domain which is used by the module G and in choosing the secret key K by using a standard cryptographic method.

Application to Authenticating Compilation

Compilation preserves the concrete semantics of the software or hardware programs to within a morphism. Consequently, compilation also preserves the secret abstract semantics of the object software or hardware program Po, which is the same as the semantics of the source program P, to within this same morphism. Hence, the compilation of a source watermarked hardware or software program PT by a correct compiler does not wash the watermark in the object hardware or software program PTo. Knowing the target computer, one knows the concrete semantics of the object code and hence that of the object hardware or software program PTo. By adapting the devices DA and DS, according to the principles of the theory of abstract interpretation, to the concrete semantics of the machine language of the computer or of the object computing system by using said compilation morphism, one obtains devices DAo and DSo which conform to the modules A and S in respect of the concrete semantics of the object code and such that the composition of DA followed by DS in respect of PT gives the same secret semantics SSS (to within said morphism) as the composition of DAo and DSo in respect of PTo. Consequently, the device DAu using the device DSo computes a representation of the secret semantic signature SSS of the program PTo, which is also that of the program PT and can therefore be used by the device DAu to retrieve the authenticator of the program PT. One of the applications of this patent is an authenticating compilation module Ca compiling a program while inserting therein a watermark according to the principles of the module G. In its preferred embodiment, an authenticating compiler Dca integrates the device DG of FIG. 7 bis into a compiler in respect of a hardware or software computer language which can be used optionally to watermark the object code. As explained hereinabove, the device DAu makes it possible to retrieve the authenticator of the watermarked object program.

(See FIG. 11)

The General Module DG

Among the preferred embodiments of the above watermarking process G, the invention also discloses a device DG (which may be embodied as a computer product/program) for concealing an authenticator Auth in the text of an original software or hardware program P (as a function of the choice of an abstract domain parameterized by a secret key).

(See FIG. 11A)

An Authentication Process Au

The authentication process Au takes as parameters, the marked software or hardware program PT and the secret abstract semantics SAS. It computes the original authentication Auth. This module A is composed of two submodules:
the module S, described above, which on the basis of the watermarked software program PT and of the secret semantics extracts the secret semantic signature SSS(PT) and consequently that SSS(m) of the mark m hidden in PT;
a deciphering and extraction module F, which is the inverse of the enciphering module C used in the watermarking module T, takes as parameter the secret semantic signature SSS(PT) so as to extract the original authenticator Auth of P.

The deciphering module F can also constitute a secret, just like the module C.

(See FIG. 12)

An Authentication Module DAu

Among the preferred embodiments of the above authentication process Au, the invention also discloses an authentication device DAu (which may be embodied as a computer product/program using the above device DS and a deciphering device DF) for the authentication of a watermarked program PT by calculating its authenticator Auth.

(See FIG. 12A)

Presentation of the Additional Figures

FIG. 5 shows a basic diagram of the process A for generating the secret abstract semantics SAS from an abstract domain Di(K) dependent on a secret key K;

FIG. 6 shows a basic diagram of the process S for calculating the signature SSS according to the secret semantics SAS of a software or hardware program P;

FIGS. 5A and 6A show the diagram of the devices DA and DS corresponding to the processes A and S in one of their variant embodiments;

FIG. 7 (respectively 7A) shows the basic diagram of the process M (respectively of the device DM in one of its variant embodiments) for producing a mark knowing a secret abstract semantics SAS (resulting for example from the application of the principle of the process of FIG. 1) and a secret semantic signature SSS;

FIG. 8 (respectively 8A) shows the basic diagram of the process B (respectively of the device DB in one of its variant embodiments) for watermarking a software or hardware program P by inserting a mark m into a selection of elements to be watermarked of said P;

FIG. 9 (respectively 9A) shows the basic diagram of the process PS (respectively of the device DPS in one of its variant embodiments) which, given a software or hardware program P, chooses an abstract domain D from a family of possible abstract domains and selects elements of P to be watermarked;

FIG. 10 (respectively 10A) shows the basic diagram of the process T (respectively of the device DT in one of its variant embodiments) for inserting a mark m characteristic of an authenticator Auth into a selection of elements of an original software or hardware program P by using a secret abstract semantics SAS;

FIG. 11 (respectively 11A) shows the basic diagram of the process T (respectively of the device DT in one of its variant embodiments) for choosing an abstract domain parameterized by a key, a particular secret key and an authenticator for watermarking a software or hardware program P by transformation into a functionally equivalent watermarked program PT;

FIG. 12 (respectively 12A) shows the basic diagram of the process Au (respectively of the device DAu in one of its variant embodiments) for authenticating a watermarked program PT.

Appendix 6

### Example 3

Let us consider a very simple original program P to be watermarked by the device DG of FIG. 11A, which is as follows:

```
    public class Fibonacci
    {
        public Fibonacci( )
        { }
        public static void main(String[ ]args)
        {
            int n=Integer.parseInt(args[0]);
            int a=0;
            int b=1;
            for (int i=1;i<n;i++)
            {
                int c=a+b;
                a=b; //a equals ui
                b=c; //b equals ui+1
            }
            System.out.printIn(“The value of the series
for n=“+n+” is: “+b);
        }
        }
```

By way of example, the device DPS of FIG. 9A selects methods to be watermarked, such as the method main.

A very simple exemplary watermarking of Java™ methods consists in using a collecting semantics which is the set of descendants of the input states of the method (other alternatives being the semantics of the ascendants of the output states or combinations such as the intersection of these collecting semantics).

In this example, the secret abstract semantics SAS is the abstraction of the collecting semantics of a method which retains only the integer local variables and takes no account whatsoever of the other variables, of the control flow graph, of the external elements and of the context of the method. Hence static analysis is insensitive to the transformations of the program (for example for the purposes of obfuscation or scrambling) modifying the control flow graph and transformations by equivalence of the arithmetic expressions. By simplicity for this example of secret abstract semantics SAS, only the basic arithmetic operations +, − and * are considered (including all the other arithmetic operations making it possible to rewrite arithmetic expressions comprising these basic operations in an arithmetically equivalent form, such as unary minus, etc.). The concrete semantics is chosen over the ring (Z, +,*) of mathematical integers (and not as integers modulo 2³² as in Java™, the arithmetic equivalences mentioned hereinabove having to take account of this fact).

In this example, the secret abstract semantics SAS uses a domain of finite height for the local integer variables, this rendering it insensitive to the chaotic iteration strategies used and precluding, still with a view to greater simplicity of the example, the use of widening and narrowing operators.

In this example, the secret key K is the product K1*K2* . . . *Kn of strictly positive and relatively prime natural integers. In the example considered below, n=2, K1=10 000 and K2=5421. The abstract domain D(K), used to compute the secret abstract semantics SAS by abstract interpretation of the collecting semantics, is that of the propagation of constants modulo K. According to the Chinese lemma, Z/_{KZ}=Z/_{K1* . . . *KnZ} is isomorphic to the product ring Z/_{K1Z}× . . . ×Z/_{KnZ}. Given the secret semantic signature SSS of the watermarked program PT in Z/_{KZ}=Z/_{K1* . . . *KnZ}, we consider its image (s1, . . . , sn) in Z/_{K1Z} x . . . x Z/_{KnZ} whose components are given by canonical projection onto the ring Z/_{KiZ}, i=1, . . . , n. In the example considered, we assume that the device DC of FIG. 6 bis computes the secret semantic signature (2507, 3012) from the authenticator of the program. The secret static semantics is then obtained through n static analyses, for all the integer variables local to the method of the abstract domains Z/_{Ki z}, i=1, . . . , n, corresponding to the propagation of constants modulo Ki. The device DA of FIG. 5A therefore consists of a program for successive static analyses by propagation of constants modulo (K1, . . . , Kn).

In this example, the device DM of FIG. 7A uses the secret abstract semantics SAS and the secret semantic signature SSS defined above to produce a mark m whose text is as follows:

int <watermark:10000:2507>;
int <tmp:10000:2507>;
<watermark:10000:2507>=1;
<tmp:10000:2507>=<watermark:10000:2507>+227492;
<tmp:10000:2507>=<watermark:10000:2507>*<tmp:10000:2507>;
<watermark:10000:2507>=<tmp:10000:2507>+155014;
<tmp:10000:2507>=<watermark:10000:2507>*1323;
<tmp:10000:2507>=<tmp:10000:2507>+153;
<tmp:10000:2507>=<tmp:10000:2507>*<watermark:10000:2507>;
<watermark:10000:2507>=<tmp:10000:2507>+9109;
int <watermark:5421:3012>;
int <tmp:5421:3012>;
<watermark:5421:3012> = 1;
<tmp:5421:3012>=<watermark:5421:3012>+−35539;
<tmp:5421:3012>=<watermark:5421:3012>*<tmp:5421:3012>;
<watermark:5421:3012>=<tmp:5421:3012>+11445;
<tmp:5421:3012>=<watermark:5421:3012>*658;
<tmp:5421:3012>=<tmp:5421:3012>+971;
<tmp:5421:3012>=<tmp:5421:3012>*watermark:5421:3012>;
<watermark:5421:3012>=<tmp:5421:3012>+4623;

In a simplified case where Ki is not too large and for a given secret semantic signature s in Z/_{KiZ}, the text of the mark m created by the device DM of FIG. 7A can consist of a single initialization mark which can be an assignment:
<watermark:Ki:s>=s′;
where s′=s+aKi and the value a in Z is not chosen too large so as to prevent s′ from overflowing outside the 32 bits of the Java integers. The value of the variable <watermark:Ki:s> is always constant in a static analysis by propagation of constants modulo Ki and equal to s. This value does not appear as plaintext in the mark and is all the more difficult to find since the secret key Ki is unknown.

A more sophisticated instantiation of the device DM of FIG. 7A makes it possible to choose this initialization mark as being a polynomial Q (in the variable <watermark:Ki:s>) of the form:
aₖ<watermark:Ki:s>^{k}+ . . . +a₁<watermark:Ki:s>+ a
where aₖ, . . . a₁ are random values and the value a is given by
a=s−aₖv^{k}−aₖ₋₁v^{k-1}− . . . −a₁v mod Ki
where the initial value v is arbitrarily chosen randomly. In this case, the initialization mark consists of the assignments:
<watermark:Ki:s>=v;
<watermark:Ki:s>=aₖ<watermark:Ki:s>^{k+} . . . +a₁<watermark:Ki:s>+a;
so that we always have:
<watermark:Ki:s>=s mod Ki

The use of a single initialization mark has the drawback of leaving the value of <watermark:Ki:s> constant and hence easily locatable by a constants-propagating static analysis. To prevent same, a more sophisticated device DM will add an induction mark affording some dynamics to the mark variable <watermark:Ki:s> so that it takes stochastic values in Z but remains constant in Z/KiZ. To do this, a polynomial Q′ is used which possesses the stability property, i.e.:
Q′(s)≡s mod Ki

The polynomial Q′ is generated as explained above and the induction mark consists of the instruction:
<watermark:Ki:s>=a′ₖ′<watermark:Ki:s>^{k′}+ . . . +a′₁<watermark:Ki:s>+a′;
or any equivalent, for example by using Horner's computation principle.

The device DB of FIG. 8A can place this induction mark in a loop or in a recursive call of the method to be watermarked in P since its execution does not modify the value of <watermark:Ki:s> in the ring Z/_{KiZ} chosen to compute the secret static semantics s. Conversely, the value observed in the domain of interpretation of Java integers will be completely stochastic.

In the example of the watermarking of the above program P, the mark defined above uses two local variables <watermark:Ki:s> and <tmp:Ki:s>. The initialization mark is the initial code segment consisting of a polynomial Q computing the initial value of <watermark:Ki:s>. The induction mark consists of a polynomial Q′ possessing the stability property for s in the ring Z/_{KiZ} considered. Second degree polynomials are used for convenience. The values of the coefficients of the second degree polynomial ensuring initialization are random. This polynomial is given as follows in Z/_{KiZ}:
Q(x)=(x−1)(x−s)=x2+coeff1.x+coeff2.

A random number of periods of the modulo Ki is added to or deducted from the coefficients so as not to divulge the key s. The initial value of <watermark:Ki:s> is therefore:
<watermark:Ki:s>=Q(1)=s in Z/_{KiZ}.

The initial mark consists in calculating this polynomial Q by using Horner's computation principle. The induction mark consists of a polynomial Q′ (likewise of second degree, here again for convenience) satisfying the stability property:
Q′(s)=s in Z/_{KiZ}

The polynomial Q′ may be written:

Q′(x)=ax²+bx+c

The coefficients a and b are drawn at random, whereas c is chosen in such a way as to ensure the stability property for the secret key, as explained above. The induction mark consists of the assignment instruction:
<watermark:Ki:s>=Q′(<watermark:Ki:s>);
where the polynomial is computed by Horner's method.

The watermarked program PT corresponding to the program P including the above mark m is as follows:

```
    public class FibonacciWatermark
    {
        public FibonacciWatermark ( )
        { }
        public static void main(String[ ] args)
        {
            int n=Integer.parseInt(args[0]);
            int a=0;
            int b=1;
            int d=1;
            int e=35538;
            int f=1;
            int g=227493;
            e=d*e;
            d=e+11445;
            g=f*g;
            f=g+155014;
            for (int i=1;i<n;i++)
            {
                int c=a+b;
                e=d*658;
                f=f*1323;
                a=b; //a equals ui
                g=g+153;
                e=e+971;
                g=g*f;
                e=e*d;
                b=c; //b equals ui+1
                d=e+4623;
                f=g+9109;
            }
            System.out.printIn(“The value of the series for n=“+n+”
is :“+b);
        }
    }
```

The location of the marks is random, in the order of the marks, the initialization mark being placed at the start of the program and the induction mark being placed preferably in a loop or in a branch for recursive calling of the method.

In the considered exemplary device DB of FIG. 8A, an additional transformation of the program is then necessary so as to link the watermark to the original program (to resist for example dewatermarking by automatic “slicing”), such as for example:

```
      public class FibonacciWatermark
      {
        public FibonacciWatermark ( )
        { }
        public static void main(String[ ] args)
        {
            int n=Integer.parseInt(args[0]);
            int a=0;
            int b=1;
            int d=1;
            int e=35538;
            int f=1;
            int g=227493;
            e=d*e;
            d=e+11445;
            g=f*g;
            f=g+155014;
            for (int i=1;i<n;i++)
            {
                int c=a+b;
                e=d*658;
                f=f*1323;
                a=b+(155014/f); //a equals ui
    g=g+153;
                e=e+971;
                g=g*f;
                e=e*d;
                b=c+(e/f); //b equals ui+1
                d=e+4623;
                b=b−(e/f);
                a=a−(155014/f);
                f=g+9109;
            }
            System.out.println(“The value of the series for n=“+n+”
is : ”+b);
        }
      }
```

The deletion of the variables d, e, f and g used for the watermarking would render the program erroneous and hence unusable.

In a more realistic example, the device DB of FIG. 8A must ensure that the transformation of the original program does not introduce errors on execution which could modify the semantics of the original program. To do this, the conventional techniques of abstract interpretation will be used.

In a more realistic example, the device DB of FIG. 8A will use more sophisticated methods for linking the mark m to the original program P in the watermarked program PT. To do this, within the framework of the example considered above, it is necessary to be able to use secret invariant properties of the watermarking variable which are transposable into 32-bit signed arithmetic. This is possible very simply when, for example, the key Ki is a power of 2. Specifically, let us assume that Ki=²k. We then have:
x=s+a.2^{k} in Z

We have, still in Z, that, for any j less than or equal to k:
x% 2^{j}=s% 2^{j}
where x % y denotes the operation which returns the remainder of the Euclidean division of x by y. It is noted that this property remains trivially true in Z/₂³²_{Z} which is the domain of Java™ integers. We can therefore use arithmetic properties of the watermark to modify computations of the method. For example, let us assume that Ki=2¹⁶ and that s=18. Then, regardless of the value of x, the invariant x % 4=2 is still satisfied. Hence, an explicit constant 2 in the original program P, can be replaced by x % 4 in the watermarked program PT. The other constants or values of variables of the watermarked program PT can also be easily computed as a function of this value. For example 1 in P will simply be replaced by (x % 4)−1 in PT.

This concludes the description of the watermarking device DT with regard to the example considered by chaining together of the devices DC, DM and DB as indicated in FIG. 10A and of the device DG by chaining together of the devices DPS, DA and DT as indicated in FIG. 11A.

In this example, the device DS of FIG. 6A computes the secret static semantics s=(s1, . . . , sn) by doing n successive static analyses of the watermarked program according to the abstract interpretation defined above consisting of a forward analysis, which may or may not ignore the control flow, with propagation of constants modulo the still-secret keys K1, . . . , Kn.

On the basis of this secret static semantics s=(s1, . . . , sn), the device DF computes the original authenticator of the program P as indicated in FIG. 8 bis.

If the domain D(K) used in the example above is public (but not the key K), then the secret static semantics s can be discovered by brute force, at least for very small programs comprising few integer variables. In a more realistic example, use will therefore be made not of the keys s1, . . . , sn coded on 32 bits, but of one or more keys s of 512 bits using, for example, arithmetic coding of the value of <watermark:Ki:s> on 16 variables of 32 bits or 8 of 64 bits or using any other technique for the computer coding of large integers.

This concludes the description of the device DAu of FIG. 12A in respect of the example considered.

Appendix 7

### Example 4

A fourth example is the following sort program:

```
private static void bubbleSort (double [ ] data, int size) {
  int index1, index2;
  double temp;
  boolean exchanged;
  for (index1 = size; index1 >= 2; index1−−) {
      exchanged = false;
      for (index2 = 1; index2 <= index1 − 1; index2++) {
          if (data [index2] > data [index2 + 1]) {
              temp = data [index2];
              data [index2] = data [index2 + 1];
              data [index2 + 1] = temp;
              exchanged = true;
          }
      }
      if (!exchanged)
          break;
  }
}
```

Once again n=2, K1=10 000 and K2=5421. The bubblesort method is watermarked twice, a first time by the same secret semantic signature (2507, 3012) as above and the 5 second time by the secret signature (9876, 2345). The second watermarking could also have been carried out for different values of K1 and K2. After compilation, watermarking, obfuscation and decompilation, the bubbleSort class is obtained as follows:

```
private static void bubbleSort (double [ ] r0, int i0) {
  int i1, i2, i3, i4, i5, i6, i7, i8, i9, i10, i11;
  double d0;
  i1 = 1;
  i2 = i1;
  i3 = i2;
  i4 = i3;
  i5 = i2 − 35539;
  i6 = i1 − 62508;
  i7 = i3 − 129877;
  i6 = i1 * i6;
  i5 = i2 * i5;
  i1 = i6 − 144986;
  i8 = i4 + 84390;
  i7 = i3 * i7;
  i2 = i5 − 75291;
  i8 = i4 * i8;
  i3 = i7 + 169752;
  i4 = i8 + 10111;
  for (i9 = i0; i9 >= 2; i9−−) {
      i10 = 0;
      for (i11 = 1; i11 <= i9 − 1; i11++) {
          if (r0 [i11] > r0 [i11 + 1]) {
              i6 = i1 * 620;
              i6 = i6 + 1151;
              d0 = r0 [i11];
              i6 = i6 * i1;
              i1 = i6 + 6570;
              r0 [i11] = r0 [i11 + 1];
              i8 = i4 * 936;
              i5 = i2 * 620;
              i5 = i5 + 1151;
              i5 = i5 * i2;
              i8 = i8 + 1057;
              i2 = i5 + 2961;
              r0 [i11 + 1] = d0;
              i7 = i3 * 1231;
              i7 = i7 + 1699;
              if ((i2 − 2961) == i5)
                  i10 = 1;
          }
          i8 = i8 * i4;
          i7 = i7 * i3;
      }
      i3 = i7 + 2696;
      i4 = i8 + 1389;
      if (i10 == 0)
          break;
  }
}
```

These devices and processes may be implemented without difficulty on commercial computers. As a function of the complexity of the software and of the signature, the execution times will be longer or shorter, in particular for the computation of the hidden variables by the fixpoint method. To limit these computation times, the methods of widening and of narrowing which are known to the person skilled in the art will be applied.

An item of software can be watermarked as often as desired (superposition of watermarks), in contra distinction to the watermarking of sounds or pictures which undergo a certain saturation of the subliminal channel (depending on the perception model chosen). The software will not be impaired, it will be overloaded, the memory and temporal resources will be affected.

Different secret semantics can be used for each of these watermarks, so that the chain of trust can have different secrets.

Of course, this device and this watermarking process can be combined with devices and processes of the prior art in order to render the program unusable to an unauthorized user (prevention) in order to trace the possible dissemination of said program by an authorized user to unauthorized users (audit). To do this it will suffice for the keys enabling authorized users to retrieve the watermark not to be communicated to them.

The device and the process can also be used to automatically authenticate the codes which will be authorized to enter a network or a given station. The watermark can be likened to an authentication certificate whose station for monitoring the network or station will be furnished with the reading key.

1. A computer product/program for processing pieces of software comprising:
a module for selecting with predefined criteria some instructions input of a transcoding program; and
a module for choosing a secret method of transcoding to be applied to said input.

2. The computer product/program as claimed in claim 1, wherein the secret transcoding method outputs a semantic signature pieces of software.

3. The computer product/program of claim 2, wherein the semantic signature of said software includes at least some of all or part of the set of properties of said pieces of software transcoded by the secret method.

4. The computer product/program of claim 4, wherein said pieces of software are written in programming language.

5. The computer product/program of claim 3, wherein said pieces of software are in a language of the Java, Java Script or Java bytecode type.

6. The computer product/program of claim 3, wherein said pieces of software are written in a language of the Very High Definition Language, Verilog or Assembler type.

7. The computer product/program of claim 1, wherein said pieces of software to which a transcoding program will be applied are chosen from one of those comprising algebraic operations and allocations to variables with integer values.

8. The computer product/program of claim 1, wherein the pieces of software to which a transcoding program will be applied are chosen from one of those comprising algebraic operations and allocations to references with integer values.

9. The computer product/program of claim 7, wherein the secret transcoding method is determined through the choice of secret integer numbers as congruence operators applied to said algebraic operations or to said allocations to variables or references with integer values.

10. The computer product/program of claim 7, wherein the secret transcoding method is determined through the secret choice of one or more variables with integer values in association with the references.

11. The computer product/program of claim 1 further comprising; a module for producing new pieces of software by inverse transcoding and inserting said new pieces of software among the original pieces of software.

12. The computer product/program of claim 11, wherein the inverse transcoded new pieces of software are inserted at positions chosen as a function of predefined criteria among the original pieces of software in the form of instructions initializing or calculating variables, said instructions comprising the application to said variables of operations which leave invariant the semantic signature of the original pieces of software.

13. The computer product/program of claim 12, wherein said operations leaving invariant the semantic signature of the original pieces of software are polynomials functions of degree 1 or of degree 2 which are created on the basis of a random coefficient and values of secret integer numbers.

14. The computer product/program of claim 11, wherein the module for inserting inverse transcoded instructions comprises a first submodule for enciphering by calculating a secret semantic signature as a function of an authenticator, a second submodule for determining a mark on the basis of the secret transcoding method and of said secret semantic signature, and a third submodule for camouflaging by producing the watermarked program on the basis of the input, of said mark and of the instructions chosen for the watermark.

15. A process for processing pieces of software comprising the steps of:
choosing as a function of predefined criteria those pieces of said software to which a transcoding program is applied; and
choosing from several the secret transcoding method to be applied to said pieces of software.

16. The process of claim 15, wherein the secret transcoding method produces a semantic signature of the pieces of software.

17. The process of claim 16, wherein the semantic signature of said pieces of software includes at least some of all or part of the set of properties of said pieces of the software transcoded by the secret method.

18. The process of claim 17, wherein said pieces of software are written in programming language.

19. The process of claim 17, wherein said pieces of software are written in a language of the Java, Java Script or Java bytecode type.

20. The process of claim 17, wherein the said pieces of software are written in a language of the Very High Definition Language, Verilog or Assembler type.

21. The process of claim 15, wherein the instructions to which a transcoding program will be applied are chosen from one of those comprising algebraic operations and allocations to variables with integer values.

22. The process of claim 15, wherein the pieces of software to which a transcoding program will be applied are chosen from those comprising algebraic operations or allocations to references with integer values.

23. The process of claim 21, wherein the secret transcoding method is determined through the choice of secret integer numbers as congruence operators applied to said algebraic operations or to said allocations to variables or references with integer values.

24. The process of claim 21, wherein the secret transcoding method is determined through the secret choice of one or more variables with integer values in association with the references.

25. The process of claim 15, further comprising steps for producing new pieces of software by the inverse transcoding and inserting new pieces of software among the original pieces of software.

26. The process of claim 25, wherein the inverse transcoded new pieces of software are inserted at positions chosen as a function of predefined criteria into the original pieces of software in the form of instructions for initializing or calculating variables, said instructions comprising the application to said variables of operations which leave invariant the semantic signature of the original pieces of software.

27. The process of claim 26, wherein said operations leaving invariant the semantic signature of the original pieces of software are polynomials functions of degree 1 or of degree 2 which are created on the basis of a random coefficient and values of secret integer numbers.

28-33. (canceled)

34. The process of claim 25, wherein the module for inserting inverse transcoded instructions comprises a first step for enciphering by calculating a secret semantic signature as a function of an authenticator, a second step for determining a mark on the basis of the secret transcoding method and of said secret semantic signature, and a third step for camouflaging by producing the watermarked program on the basis of the input, of said mark and of the instructions chosen for the watermark.

35. Computer product/program for processing pieces of software comprising a decyphering module enabling a user knowing the parameter/parameters of the secret method of claim 1 to recognize the signature of said pieces of software.

36. The computer product/program of claim 35, wherein said decyphering module comprises a semantic static analysis program for recognizing the signature.

37. The computer product/program of claims 35, wherein said decyphering module comprises a program for calculating the fixpoint of the values of all or some of the variables.

38. A process for processing pieces of software comprising a decyphering step whereby a user knowing the parameter/parameters of the secret method of claim 15 is able to recognize the signature of the pieces of software.

39. The process of claim 38 comprising a semantic static analysis step for recognizing the signature.

40. The process of claims 38, wherein said decyphering step comprises a step for calculating the fixpoint of the values of all or some of the variables.
